(19) United States
(12) Patent Application Publication
(10) Pub. No.: US 2025/0056300 A1
(43) Pub. Date: Feb. 13, 2025

(54) METHOD AND APPARATUS FOR CONTROLLING QUALITY OF EXPERIENCE IN WIRELESS COMMUNICATION SYSTEM

(71) Applicant: Samsung Electronics Co., Ltd., Suwon-si (KR)

(72) Inventors: Changsung LEE, Suwon-si (KR); Suhwook KIM, Suwon-si (KR); Sooeun SONG, Suwon-si (KR); Jaehong YI, Suwon-si (KR)

(21) Appl. No.: 18/523,126

(22) Filed: Nov. 29, 2023

(30) Foreign Application Priority Data
Aug. 9, 2023 (KR) 10-2023-0104343

(51) Int. Cl. H04W 28/02

(52) U.S. Cl. CPC H04W 28/0236; H04W 28/0268

(57) ABSTRACT

A fifth-generation (5G) or sixth-generation (6G) communication system for supporting higher data rates after fourth-generation (4G) communication system such as long-term evolution (LTE) is provided. In the communication system, a centralized unit (CU) is provided. The CU transmits, to a distributed unit (DU), a message requesting information for determination of quality of experience (QoE) bottleneck, receives, from the DU, a message including the information for determination of QoE bottleneck, determines a QoE bottleneck factor based on the received information for determination of QoE bottleneck, wherein the QoE bottleneck factor is associated with a traffic state in a radio access network (RAN) or a core network, and performs QoE control based on the determined QoE bottleneck factor.

### CROSS-REFERENCE TO RELATED APPLICATION(S)

This application is based on and claims priority under 35 U.S.C. § 119 (a) of a Korean patent application number 10-2023-0104343, filed on Aug. 9, 2023, in the Korean Intellectual Property Office, the disclosure of which is incorporated by reference herein in its entirety.

### BACKGROUND

### 1. Field

The disclosure relates to a wireless communication system. More particularly, the disclosure relates to a method and apparatus for enhancing performance felt by the user, i.e., quality of experience (QoE), in a wireless communication system that supports dual connectivity.

### 2. Description of Related Art

Looking back through successive generations at a process of development of radio communication, technologies for human-targeted services such as voice, multimedia, data or the like have been developed. Connected devices that are on the explosive rise after commercialization of fifth-generation (5G) communication systems are expected to be connected to communication networks. Examples of things connected to networks include cars, robots, drones, home appliances, displays, smart sensors installed in various infrastructures, construction machinery, factory equipment, and more. Mobile devices are expected to evolve into various form factors such as augmentation reality (AR) glasses, virtual reality (VR) headsets, hologram devices, and the like. In order to provide various services by connecting hundreds of billions of devices and things in the sixth-generation (6G) era, there are ongoing efforts to develop better 6G communication systems. For these reasons, 6G communication systems are referred to as beyond-5G systems.

In the 6G communication system expected to become a reality by around 2030, a maximum transfer rate is tera bits per second (bps), i.e., 1000 giga bps, and a maximum wireless delay is 100 microseconds (usec). In other words, compared to the 5G communication system, the transfer rate is 50 times faster and the wireless delay is reduced to a tenth ( 1/10) in the 6G communication system.

To attain these high data transfer rates and ultra-low delay, the 6G communication system is considered to be implemented in the terahertz (THz) band (e.g., ranging from 95 gigahertz (GHz) to 3 THz). Due to the more severe path loss and atmospheric absorption phenomenon in the THz band as compared to the millimeter wave (mmWave) band introduced in 5G systems, importance of technology for securing a signal range, i.e., coverage, is expected to grow. As major technologies for securing coverage, radio frequency (RF) elements, antennas, new waveforms superior to orthogonal frequency division multiplexing (OFDM) in terms of coverage, beamforming and massive multiple-input and multiple-output (massive MIMO), full dimensional MIMO (FD-MIMO), array antennas, multiple antenna transmission technologies such as large-scale antennas, etc., need to be developed. Besides, new technologies for increasing coverage of THz band signals, such as metamaterial based lenses and antennas, a high-dimensional spatial multiplexing technique using orbital angular momentum (OAM), reconfigurable intelligent surface (RIS), etc., are being discussed.

Furthermore, in order to enhance frequency efficiency and system networks, a full duplex technology by which both uplink and downlink transmissions use the same frequency resource at the same time, a network technology that comprehensively uses satellite and high-altitude platform stations (HAPS) and the like, a network structure innovation technology supporting mobile base stations and allowing optimization and automation of network operation, a dynamic spectrum sharing technology through collision avoidance based on spectrum usage prediction, an artificial intelligence (AI) based communication technology to realize system optimization by using AI from the designing stage and internalizing an end-to-end AI supporting function, a next generation distributed computing technology to realize services having complexity beyond the limit of terminal computing capability by using ultrahigh performance communication and computing resources (e.g., mobile edge computing (MEC) cloud) are being developed in the 6G communication system. In addition, by designing new protocols to be used in 6G communication systems, developing mechanisms for implementing a hardware-based security environment and safe use of data, and developing technologies for protecting privacy, attempts to strengthen connectivity between devices, further optimize the network, promote softwarization of network entities, and increase the openness of wireless communication are continuing.

With such research and development of the 6G communication system, it is expected that new levels of the next hyper-connected experience become possible through hyper-connectivity of the 6G communication system including not only connections between things but also connections between humans and things. Specifically, it is predicted that services such as truly immersive extended reality (truly immersive XR), high-fidelity mobile hologram, digital replica, and the like may be provided. Furthermore, services such as remote surgery, industrial automation and emergency response with enhanced security and reliability may be provided through the 6G communication system to be applied in various areas such as industry, medical care, vehicles, appliances, etc.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for controlling quality of experience (QoE) in a wireless communication system that supports dual connectivity.

Additional aspects will be set forth in part in the description which follows and, in part, will be apparent from the description, or may be learned by practice of the presented embodiments of the disclosure.

In accordance with an aspect of the disclosure, a centralized unit (CU) for controlling quality of experience (QoE) in a wireless communication system which supports dual connectivity is provided. The CU includes a transceiver, and at least one processor connected to the transceiver, wherein the at least one processor is configured to transmit, to a distributed unit (DU), a message requesting information for determination of QoE bottleneck, receive, from the DU, a message including the information for determination of QoE bottleneck, determine a QoE bottleneck factor based on the received information for determination of QoE bottleneck, wherein the QoE bottleneck factor is associated with a traffic state in a radio access network (RAN) or a core network, and perform QoE control based on the determined QoE bottleneck factor.

In accordance with another aspect of the disclosure, a DU for controlling QoE in a wireless communication system which supports dual connectivity is provided. The DU includes a transceiver, and at least one processor connected to the transceiver, wherein the at least one processor is configured to receive, from a CU, a message requesting information for determination of QoE bottleneck, transmit, to the CU, a message including the information for determination of QoE bottleneck, wherein the information for determination of QoE bottleneck is used to determine a QoE bottleneck factor, and the QoE bottleneck factor is associated with a traffic state in a RAN or core network, and receive, from the CU, information about data or changed QoS as a result of performing QoE control based on the QoE bottleneck factor.

In accordance with another aspect of the disclosure, a method of operating a CU for controlling QoE in a wireless communication system which supports dual connectivity is provided. The method includes transmitting, to a DU, a message requesting information for determination of QoE bottleneck, receiving, from the DU, a message including the information for determination of QoE bottleneck, determining a QoE bottleneck factor based on the received information for determination of QoE, wherein the QoE bottleneck factor is associated with a traffic state in a RAN or a core network, and performing QoE control based on the determined QoE bottleneck factor.

In accordance with another aspect of the disclosure, a method of operating a DU for controlling QoE in a wireless communication system which supports dual connectivity is provided. The method includes receiving, from a CU, a message requesting information for determination of QoE bottleneck, transmitting, to the CU, a message including the information for determination of QoE bottleneck, wherein the information for determination of QoE bottleneck is used to determine a QoE bottleneck factor, and the QoE bottleneck factor is associated with a traffic state in a RAN or core network, and receiving, from the CU, information about data or changed QoS as a result of performing QoE control based on the QoE bottleneck factor.

In accordance with another aspect of the disclosure, a computer-readable recording medium storing a program to execute at least one of the embodiments of the disclosure, on a computer is provided.

Other technical features may be clearly understood by those of ordinary skill in the art with reference to accompanying drawings, descriptions and appended claims.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing a technical field and purpose according to an embodiment of the disclosure;

FIG. 2 illustrates a structure of a master node (MN) terminated split bearer in a wireless communication system that supports dual connectivity, according to an embodiment of the disclosure;

FIG. 3 is a flowchart for describing a method by which an MN centralized unit (CU) controls quality of experience (QoE) in a wireless communication system that supports dual connectivity, according to an embodiment of the disclosure;

FIG. 4 is a flowchart for describing a method by which a CU controls QoE in a wireless communication system that supports dual connectivity, according to an embodiment of the disclosure;

FIG. 5 is a diagram for describing how an MN-CU requests information for determination of QoE bottleneck, according to an embodiment of the disclosure;

FIG. 6 is a diagram for describing an operation of an MN-CU controlling QoE based on a determined QoE bottleneck factor in detail, according to an embodiment of the disclosure;

FIGS. 7A and 7B are diagrams for describing how an MN-CU determines a QoE bottleneck factor, according to various embodiments of the disclosure;

FIGS. 8A and 8B are diagrams for describing a procedure in which an MN-CU transmits a message requesting information for determination of QoE bottleneck based on a QoE evaluation result, according to various embodiments of the disclosure;

FIG. 9 is a flowchart for describing a method by which a distributed unit (DU) controls QoE in a wireless communication system that supports dual connectivity, according to an embodiment of the disclosure;

FIG. 10A is a diagram for describing a structure of a secondary node (SN) terminated split bearer, according to an embodiment of the disclosure;

FIG. 10B is a diagram for describing a method of controlling QoE in a structure of an SN terminated split bearer, according to an embodiment of the disclosure;

FIG. 11A is a diagram for describing a structure of an MN terminated MCG SCG bearer, according to an embodiment of the disclosure;

FIG. 11B is a diagram for describing a method of controlling QoE in a structure of an MN terminated MCG SCG bearer, according to an embodiment of the disclosure;

FIG. 12A is a diagram for describing a structure of an SN terminated MCG SCG bearer, according to an embodiment of the disclosure;

FIG. 12B is a diagram for describing a method of controlling QoE in a structure of an SN terminated MCG SCG bearer, according to an embodiment of the disclosure;

FIG. 13 is a block diagram of a CU, according to an embodiment of the disclosure; and

FIG. 14 is a block diagram of a DU, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these to be regarded as are merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, some parts in the accompanying drawings are exaggerated, omitted or schematically illustrated. The size of the respective elements may not fully reflect their actual size. Like numbers refer to like elements throughout the drawings.

Ordinal numbers (e.g., first, second, etc.) as used in the specification are to distinguish components from one another.

Advantages and features of the disclosure, and methods for achieving them will be understood more clearly when the following embodiments are read with reference to the accompanying drawings. The various embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art. Like numbers refer to like elements throughout the specification. In the description of the disclosure, when it is determined that a detailed description of related functions or configurations may unnecessarily obscure the subject matter of the disclosure, the detailed description will be omitted. Further, the terms, as will be mentioned later, are defined by taking functionalities in the disclosure into account, but may vary depending on practices or intentions of users or operators. Accordingly, the terms should be defined based on descriptions throughout this specification.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

A base station (BS) as herein used may refer to an entity for performing resource allocation for a user equipment (UE) and may be at least one of new generation radio access network (NG-RAN), gNode B, eNode B, Node B or xNode B, where x indicates any letter including ‘g’ and ‘e’, a radio access unit, a BS controller, a satellite, an airborne vehicle or a node in a network. A distributed BS may be separated into a centralized unit (CU) and a distributed unit (DU). The CU may provide support for a higher layer protocol layer such as a service data adaptation protocol (SDAP), radio resource control (RRC) or packet data convergence protocol (PDCP) layer, and the DU may provide support for a lower layer protocol layer such as a radio link control (RLC), medium access control (MAC) or physical (PHY) layer. There may be a single CU in each gNodeB, which may be connected to many DUs, and the DU may include both baseband processing and radio frequency (RF) functions and support various mobility scenarios.

The UE may include a mobile station (MS), a vehicle, a satellite, an airborne vehicle, a cellular phone, a smart phone, a computer, or a multimedia system having a communication function.

The disclosure may be applied to a wireless communication system that supports dual connectivity, and the dual connectivity refers to a technology that enables a UE to transmit and receive data to and from two different BSs simultaneously while connected to the BSs in a wireless communication system, and was introduced by the 3rd generation partnership project (3GPP) release 12. Multi-radio dual connectivity (MR-DC) in particular refers to a technology that enables one UE that makes dual connection with two BSs in different radio resources to transmit and receive data to and from the respective BSs. The disclosure may be applied to an evolved universal mobile telecommunication system (UMTS) terrestrial radio access network (E-UTRA) new radio (NR) dual connectivity (EN-DC), NR E-UTRA dual connectivity (NE-DC), next generation radio access network (RAN) E-UTRA NR dual connectivity (NGEN-DC), and NR-NR dual connectivity (NR-DC) among various types of MR-DC, without being limited thereto. In MR-DC, a master node (MN) refers to a node to provide connection with a control plane of a core network, and a secondary node (SN) refers to a node that has no connection with the control plane of the core network and provides an additional resource for the UE. A master cell group (MCG) is a serving cell group associated with the MN, including a primary cell (PCell) and optionally one or more secondary cells (SCells), and initiates random access. A secondary cell group (SCG) is a serving cell group associated with the SN and includes a primary and secondary cell (PSCell) and optionally one or more SCells.

Although the following embodiments of the disclosure will be focused on the long-term evolution (LTE), LTE-Advanced (LTE-A) or a fifth generation (5G) system as an example, they may be applied to other communication systems with similar technical backgrounds or channel types. For example, the other communication systems may include a 5G-Advanced, new radio (NR)-Advanced or sixth generation (6G) mobile communication technology developed after the 5G mobile communication technology (or NR), and the term 5G may be a concept including the existing LTE, LTE-A and other similar services. Furthermore, various embodiments of the disclosure will also be applied to different communication systems with some modifications to such an extent that does not significantly deviate the scope of the disclosure when judged by skilled people in the art.

It will be understood that each block and combination of the blocks of a flowchart may be performed by computer program instructions. The computer program instructions may be loaded on a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or in reverse order depending on the corresponding functions.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a smaller number of components and modules, or further divided into a larger number of components and modules. Moreover, the components and modules may be implemented to execute one or more central processing units (CPUs) in a device or security multimedia card. In various embodiments of the disclosure, the module may include one or more processors.

In the following description, the terms referring to broadcast information, control information, state changes (e.g., events), network entities, messages, and components of an apparatus, the terms related to communication coverage, etc., are mentioned for convenience of explanation. The disclosure is not limited to the terms as will be used in the following description, and may use different terms having the same meaning in a technological sense.

In the following description, for convenience of explanation, terms and definitions used in the most recent standards among the currently existing communication standards, i.e., in the LTE and NR standard defined in the 3rd Generation Partnership Project (3GPP) will be used in the disclosure. The disclosure is not, however, limited to the terms and definitions, and may be equally applied to any systems that conform to other standards.

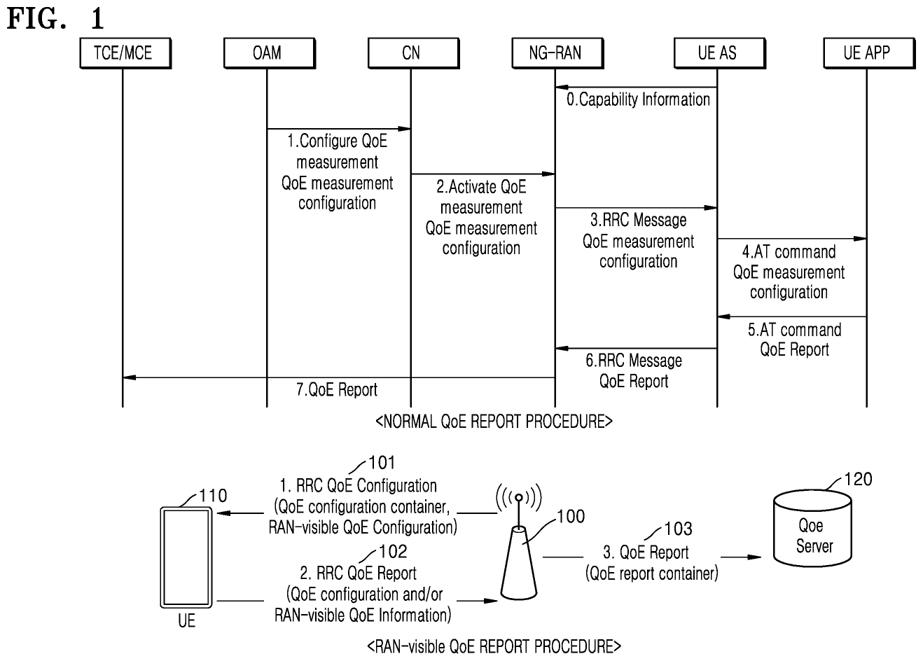

FIG. 1 is a diagram for describing a technical field and purpose according to an embodiment of the disclosure.

Referring to FIG. 1, in a wireless communication system, quality of experience (QoE) refers to a measure of quality (or performance) felt by the user. 3GPP supports a function to measure and collect performance of an application layer to enhance QoE of the user, and examples of services supported as such include a streaming service, a multimedia telephony service identity (MTSI), virtual reality, a multimedia broadcast multicast service (MBMS), extended reality (XR), etc., Throughout the specification, ‘control(ing) QoE’ means optimizing a network to enhance QoE of the user based on a QoE measurement result.

Referring to FIG. 1, shown are normal QoE report procedure and RAN-visible QoE report procedure defined by the 3GPP TS 38.890. Referring to FIG. 1, in the normal QoE report procedure, QoE measurement is configured by operation administration maintenance (OAM), and the QoE measurement result (QoE report) is collected by a trace collection entity (TCE)/measurement collection entity (MCE). An NG-RAN 100 has not been able to read or understand the QoE measurement result and thus, has not been able to use the QoE measurement result for network optimization. Hence, 3GPP has introduced RAN-visible QoE (RVQoE), a form for the RAN to be able to read the QoE measurement result and use it for network optimization.

In operation 101 of the RVQoE report procedure, the NG-RAN 100 may transmit, to a UE 110, an RVQoE configuration along with a QoE measurement configuration container transmitted from OAM directly or through a core network (CN).

In operation 102, the UE 110 may receive and apply the QoE measurement configuration container and/or RVQoE configuration. RVQoE information corresponding to the RVQoE configuration may be a value or a combination of values abstracted from a QoE metric collected by the UE and valid for the RAN. As an example of the QoE metric, there is AppLayerBufferLevel or playoutDelayForMediaStartup defined in TS 38.331, and in addition, round-trip time, jitter duration, corruption duration, average throughput, etc., defined in TS 38.890, without being limited thereto. Apart from the QoE metric, a QoE value may be used for the QoE measurement report. The QoE value refers to a series of values derived from QoE metric data through a model and function defined in common with SA4 of 3GPP, and includes, for example, a mean opinion score (MOS) without being limited thereto. The UE 110 may transmit a QoE report container to the NG-RAN 100 along with the RVQoE information.

In operation 103, the NG-RAN 100 may read the RVQoE information or forward the QoE report container to a QoE server 120. Even an OAM server may generate the RVQoE report and transmit the RVQoE report to the NG-RAN 100.

As such, a method of reporting QoE that may be read by the RAN is defined in 3GPP, but in order to enhance QoE of the user, a method by which the RAN uses the reported QoE information to control QoE is required. Specifically, when application performance of the UE is degraded, i.e., QoE is degraded, what the factor is needs to be determined and there is a need to perform network optimization corresponding to each factor. Furthermore, for such precise QoE control, there is a need to collect information relating to an additional RAN apart from RVQoE previously reported to the RAN. The disclosure provides a method by which the RAN detects QoE degradation and figures out a QoE bottleneck factor based on additionally collected RAN information for network optimization for each QoE bottleneck factor, thereby enhancing QoE of the user.

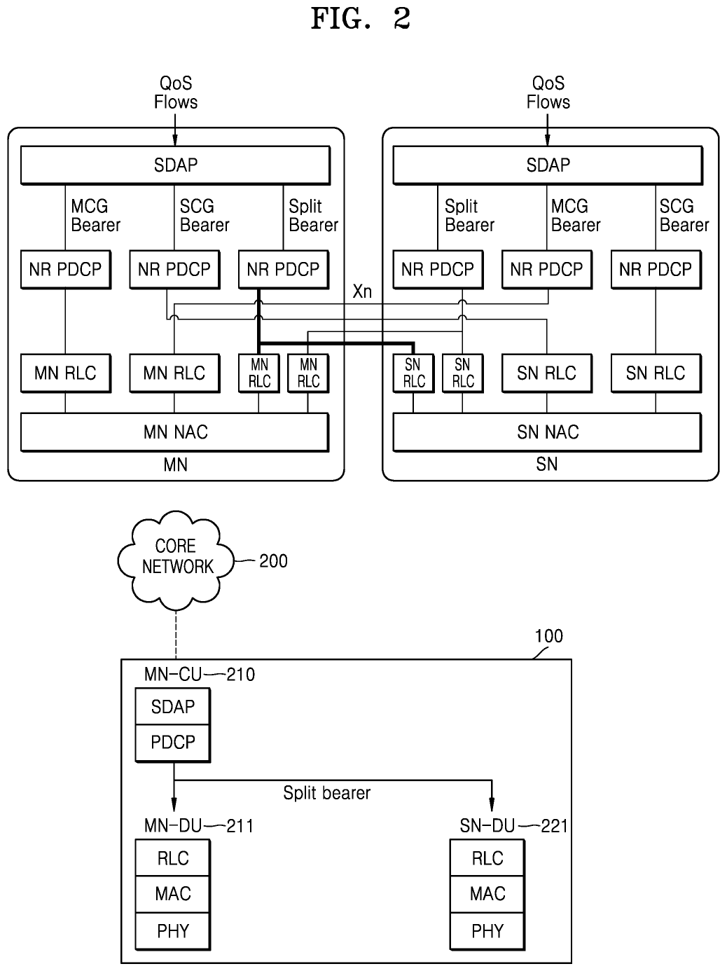

FIG. 2 illustrates a structure of an MN terminated split bearer in a wireless communication system that supports dual connectivity, according to an embodiment of the disclosure.

Referring to FIG. 2, in dual connectivity, the UE is generally connected to two cell groups, a master cell group (MCG) and a secondary cell group (SCG), and the two cell groups may each be handled by a different BS. Referring to FIG. 2, a radio bearer may be generally handled by one of the cell groups like an MCG bearer and an SCG bearer of FIG. 2. The MCG bearer refers to an MN terminated bearer, and the SCG refers to an SN terminated bearer. Herein, the expression ‘X node terminated’ indicates that a packet data convergence protocol (PDCP) of the X node is used for the bearer. For example, when a PDCP is used in the MN, it is referred to as ‘MN terminated’ and when a PDCP is used in the SN, it is referred to as ‘SN terminated’.

Like a split bearer of FIG. 2, it is possible to split a bearer as if one radio bearer is handled by two cell groups in dual connectivity. This is referred to as a split bearer method. FIG. 2 shows an MN terminated split bearer structure, and a PDCP belonging to an MN-CU 210 connected to a core network (or CN) 200 may serve to distribute traffic coming into RLC of an MN-DU 211 and RLC of an SN-DU 221. The MN-CU 210, the MN-DU 211 and the SN-DU 221 may be included in the NG-RAN 100 of FIG. 1.

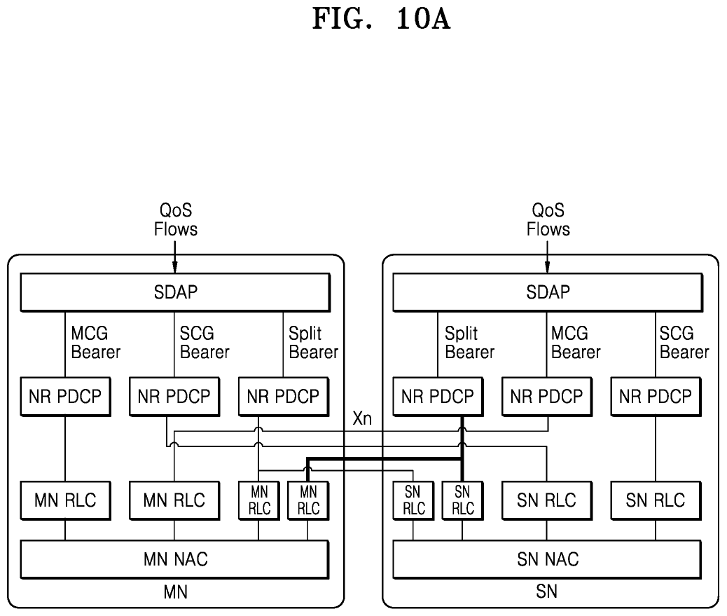

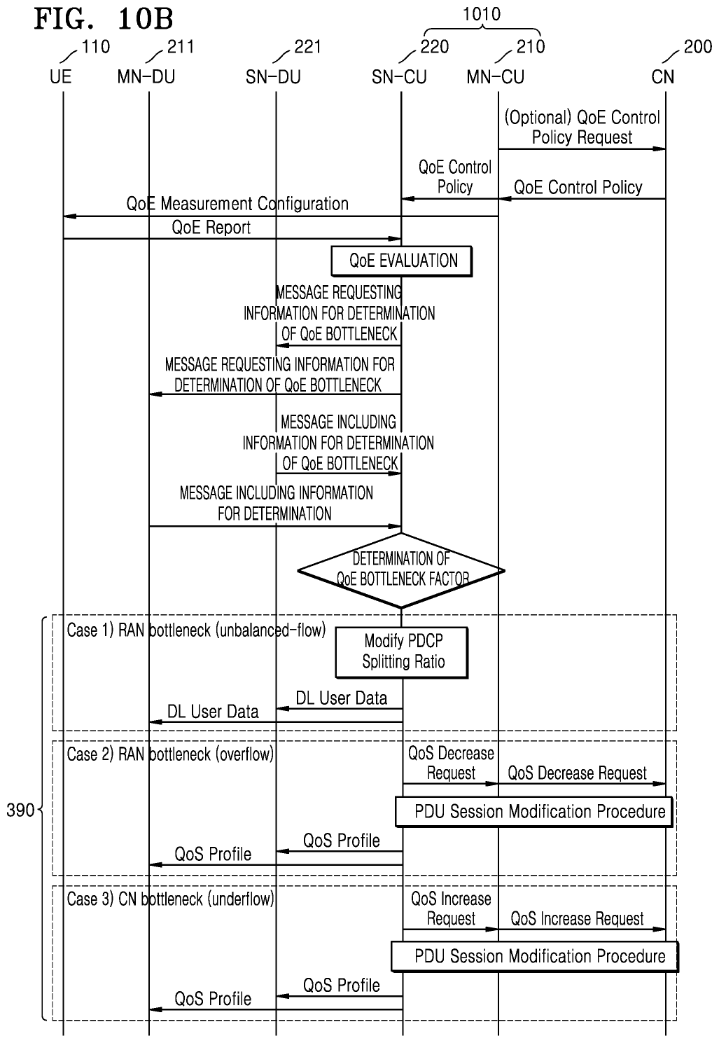

Various embodiments of the disclosure may be applied not only to the MN terminated split bearer structure shown in FIG. 2 but also to SN terminated split bearer, MN terminated MCG SCG bearer and SN terminated MCG SCG bearer structures (see FIGS. 10A to 12B for detailed description of the structures). They are not, however, limited thereto but may be applied to other various bearer structures that may be implemented in dual connectivity.

A method by which a RAN controls QoE in a wireless communication system that supports dual connectivity will now be described based on the MN terminated split bearer structure for convenience of explanation.

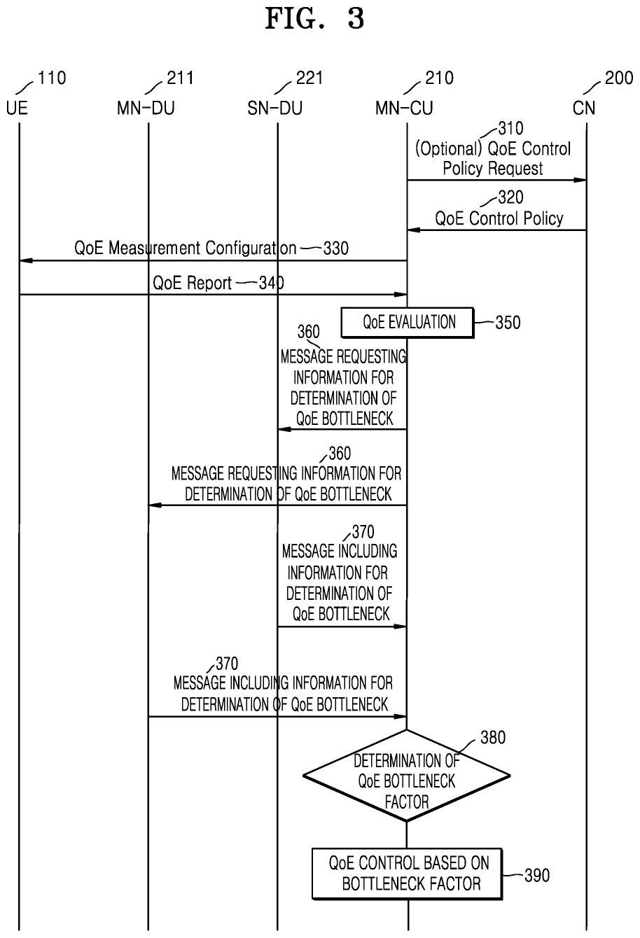

FIG. 3 is a flowchart for describing a method by which an MN-CU controls QoE in a wireless communication system that supports dual connectivity, according to an embodiment of the disclosure.

Referring to FIG. 3, in operation 310, the MN-CU 210 may transmit, to the CN 200 (e.g., a policy control function (PCF)), a message requesting a QoE control policy. The CN 200 may include a network entity, which may be, for example, a PCF, without being limited thereto.

In operation 320, the MN-CU 210 may receive a QoE control policy from the CN 200 (e.g., the PCF). The MN-CU 210 may receive the QoE control policy from the CN 200 by RRC signaling. According to an embodiment of the disclosure, the MN-CU 210 may receive the QoE control policy from the CN 200 as a response to the message requesting the QoE control policy transmitted from the MN-CU 210 in operation 310. According to another embodiment of the disclosure, the MN-CU 210 may receive the QoE control policy from the CN 200 even without transmitting a request message in operation 310. In this case, the CN 200 may transmit the QoE control policy to the MN-CU 210 periodically or randomly based on a certain standard.

The QoE control policy may include an identity (ID) of the UE and a QoE measurement configuration ID (e.g., measConfigAppLayerId), and the UE may have a QoE measurement configuration corresponding to each of a plurality of applications. The CN 200 may transmit a control policy corresponding to a certain application for which QoE measurement of a certain UE is configured, based on the UE ID and the QoE measurement configuration ID included in the QoE control policy.

The QoE control policy corresponding to the certain application may include a policy related to QoE evaluation and/or a policy related to determination of a QoE bottleneck factor.

The policy related to QoE evaluation may include information required to determine whether the RVQoE information (102 in FIG. 1 or 340 in FIG. 3) received by the MN-CU 210 from the UE 110 meets a certain condition, e.g., information about a QoE measurement object, a threshold, a timer, etc.

The policy related to determination of a QoE bottleneck factor may include information required to determine whether information (370 in FIG. 3) for determination of QoE bottleneck received from the MN-DU 211 and/or the SN-DU 221 meets a certain condition, e.g., information about a RAN measurement object, a threshold, a timer, etc.

In operation 330, the MN-CU 210 may transmit a QoE measurement configuration to the UE 110. Operation 330 may be performed similarly to operation 101 of FIG. 1, and the QoE measurement configuration may include the QoE measurement configuration container and/or RVQoE configuration of FIG. 1.

In operation 340, the MN-CU 210 may receive a QoE report from the UE 110. Operation 340 may be performed similarly to operation 102 of FIG. 1, and the QoE report may include the RVQoE information and/or QoE report container of FIG. 1. The QoE report may be represented with QoE measurement information or a QoE measurement result.

In operation 350, the MN-CU 210 may evaluate QoE based on the policy related to QoE evaluation received in operation 320 and/or the QoE measurement information received in operation 340. The MN-CU 210 may determine whether QoE is degraded, i.e., whether a QoE degradation condition is satisfied, based on the policy related to QoE evaluation received in operation 320 and/or the QoE measurement information received in operation 340.

For example, the MN-CU 210 may determine whether the measurement included in the QoE report received from the UE 110 becomes bigger than a predefined threshold for a time of a certain timer, when the QoE measurement object included in the policy related to QoE evaluation is a QoE metric (e.g., jitter duration). For example, the MN-CU 210 may determine whether the measurement included in the QoE report received from the UE 110 becomes smaller than the predefined threshold for a time of a certain timer, when the QoE measurement object included in the policy related to QoE evaluation is a QoE value (e.g., MOS).

In operation 360, the MN-CU 210 may transmit, to the MN-DU 211 and/or the SN-DU 221, a message requesting information for determination of QoE bottleneck. The information for determination of QoE bottleneck may refer to additional information distinguished from the QoE report received from the UE 110 and required for the MN-CU 210 to determine a QoE bottleneck factor to perform QoE control.

The MN-CU 210 may transmit a message requesting information for determination of QoE bottleneck to the MN-DU 211 and/or the SN-DU 221 when QOE degradation is detected as a result of QoE evaluation performed in operation 350.

The MN-CU 210 may transmit a message requesting information for determination of QoE bottleneck to the MN-DU 211 and/or the SN-DU 221 when transmitting the QoE measurement configuration to the UE 110 regardless of QoE evaluation.

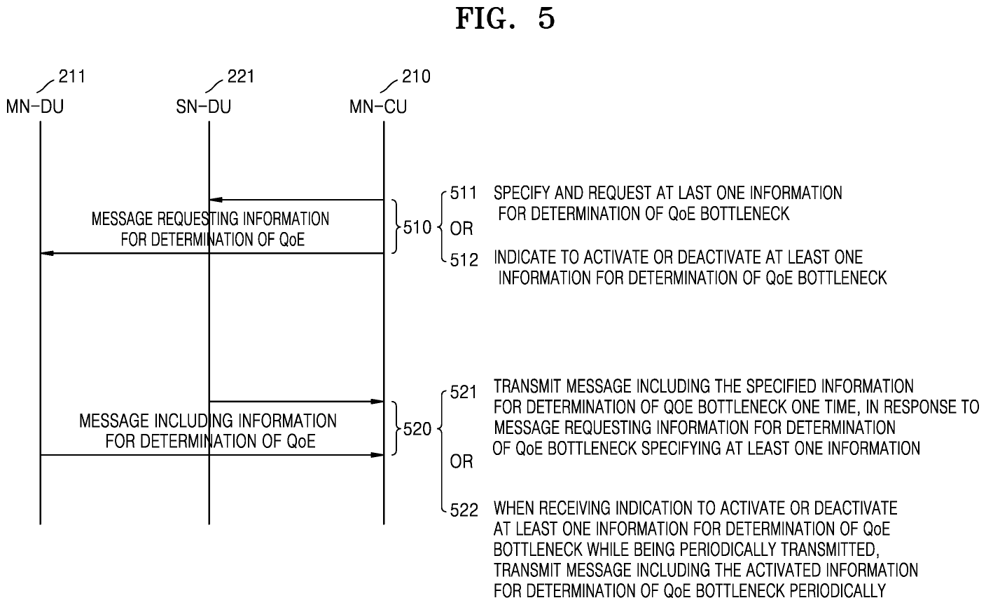

The message requesting information for determination of QoE bottleneck may specify at least one piece of information for determination of QoE bottleneck. The message requesting information for determination of QoE bottleneck may indicate to activate or deactivate at least one piece of information for determination of QoE bottleneck. How to request the information for determination of QoE bottleneck will be described in detail in connection with FIG. 5.

In operation 370, the MN-CU 210 may receive, from the MN-DU 211 and/or the SN-DU 221, a message including information for determination of QoE bottleneck.

The information for determination of QoE bottleneck may include at least one of:
RLC buffer occupancy (BO)
transport block size (TBS)
scheduling probability (SP)
queuing delay.

Relationships between pieces of information for determination of QoE bottleneck may be expressed as in Equation 1:

$${T}_{Queueing} ∝ \frac{BO}{SP \cdot TBS} [ sec ] \qquad Equation 1$$

RLC BO refers to a value indicating data queued in an RLC buffer in bytes in a data radio bearer (DRB), the value proportional to a queuing delay value, and corresponds to a most meaningful parameter when used alone in estimating queuing delay. TBS refers to a value indicating an average TBS value in bytes in the DRB, and link capacity may be estimated via the TBS. SP refers to the number of times that an MAC scheduler schedules the DRB during a unit time. Queuing delay refers to an average queuing delay time (milliseconds (ms)) of an RLC buffer measured by a DU.

The MN-CU 210 may receive the queuing delay value alone as the information for determination of QoE bottleneck. In an embodiment of the disclosure, the MN-CU 210 may receive a value of combination of at least one of RLC BO, TBS or SP value as information for determination of QoE bottleneck. For example, the MN-CU 210 may receive a value of SP*TBS=R defined as a parameter referred to as a link data rate alone or along with a value of BO, as information for determination of QoE bottleneck.

The information for determination of QoE bottleneck is not limited to the examples listed above, but may include all information about the RAN that may be used for determining QoE bottleneck in the wireless communication system.

According to an embodiment of the disclosure, a message including the information for determination of QoE bottleneck may correspond to a downlink data delivery status (DDDS) format defined in 3GPP TS 38.425. The MN-DU 211 or the SN-DU 221 may place the information for determination of QoE bottleneck in the DDDS format and transmit the information to the MN-CU 210.

Table 1 represents a DDDS transmission procedure defined in 3GPP TS38.425.

TABLE 1
FIG. 5.4.2.1-1: Successful Downlink Data Delivery Status

[symbol]

Table 2 represents a DDDS format defined in 3GPP TS38.425.

TABLE 2

| Bits | | | | | | | | Number of |
|---|---|---|---|---|---|---|---|---|
| 7 | 6 | 5 | 4 | 3 | 2 | 1 | 0 | Octets |
| PDU Type (=1) | | | | Highest | Highest | Final | Lost | 1 |
| | | | | Transmitted | Delivered | Frame | Packet | |
| | | | | NR | NR | Ind. | Report | |
| | | | | PDCP | PDCP | | | |
| | | | | SN Ind | SN Ind | | | |
| Spare | Feedback | NR-U | Delivered | Data | Retrans- | Delivered | Cause | 1 |
| | Delay | SN Ind. | NR | rate | mitted | Retrans- | Report | |
| | Ind. | | PDCP | Ind. | NR | mitted | | |
| | | | SN | | PDCP | NR | | |
| | | | Range | | SN Ind | PDCP | | |
| | | | Ind | | | SN Ind | | |

| | |
|---|---|
| Desired buffer size for the data radio bearer | 4 |
| Desired Data Rate | 0 or 4 |
| Number of lost NR-U Sequence Number ranges reported | 0 or 1 |
| Start of lost NR-U Sequence Number range | 0 or (6* |
| End of lost NR-U Sequence Number range | Number of |
| | reported lost |
| | NR-U SN |
| | ranges) |
| Highest successfully delivered NR PDCP Sequence Number | 0 or 3 |
| Highest transmitted NR PDCP Sequence Number | 0 or 3 |
| Cause Value | 0 or 1 |
| Successfully delivered retransmitted NR PDCP Sequence Number | 0 or 3 |
| Retransmitted NR PDCP Sequence Number | 0 or 3 |
| Number of successfully delivered out of sequence PDCP Sequence Number range | 0 or 1 |
| Start of successfully delivered out of sequence PDCP Sequence Number range | 0 or (6* |
| End of successfully delivered out of sequence PDCP Sequence Number range | Number of |
| | successfully |
| | delivered out |
| | of sequence |
| | PDCP |
| | Sequence |
| | Number |
| | range) |
| NR-U Sequence Number of Polling Frame | 0 or 3 |
| Feedback Delay Result | 0 or 4 |
| Padding | 0-3 |

### FIG. 5.5.2.2-1: DL Data Delivery Status (PDU Type 1) Format

Parameters included in the existing DDDS format as shown in Table 2 (e.g., a desired buffer size for the data radio bearer and a desired data rate) are to calculate and transmit a data rate and a buffer size that the MN-DU and/or the SN-DU wants to receive. Hence, the MN-CU may not know of a current accurate buffer and link conditions of the MN-DU and/or the SN-DU. For the MN-CU to perform QoE control to enhance QoE of the user in the wireless communication system that supports dual connectivity, a PDCP of the MN-CU that splits traffic needs to know of accurate buffer and link conditions of the MN-DU and/or SN-DU and based on this, calculate an amount of traffic required for the MN-DU and/or SN-DU. Accordingly, information for additional QoE determination, which is distinguished from the parameters included in the existing DDDS is required.

A message including the information for determination of QoE bottleneck may correspond to a new message different from the DDDS.

In operation 380, the MN-CU 210 may determine a QoE bottleneck factor based on the information for determination of QoE bottleneck. In an embodiment of the disclosure, the QoE bottleneck factor may be related to traffic status in the RAN or the CN. For example, the QoE bottleneck factor may include at least one of:
unbalance flow: referring to a state in which the traffic coming into the MN-DI and the SN-DU is unbalanced
overflow: referring to a state in which buffer overflow occurs due to excessive traffic transmission of the CN
underflow: referring to a state in which buffer underflow occurs due to traffic transmission of the CN slower than in the radio link.

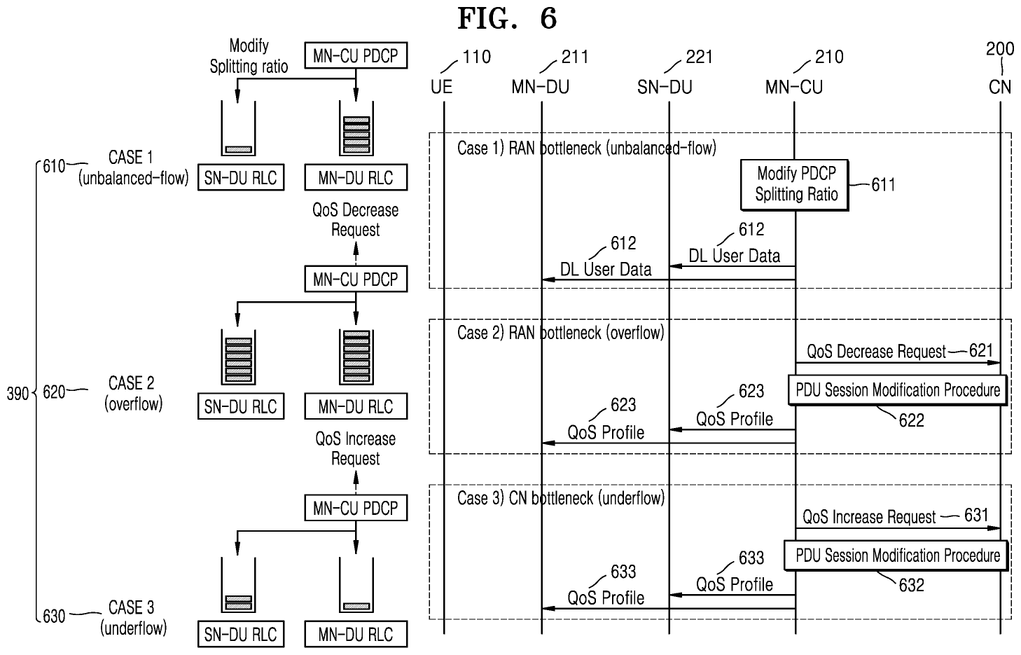

A specific example of each of the QoE bottleneck factors listed above will be described in connection with FIG. 6. The QoE bottleneck factor is not limited to the examples as listed above, but may include any situation (or condition) that may be determined as a QoE bottleneck factor in the wireless communication system.

In an embodiment of the disclosure, the MN-CU 210 may determine a QoE bottleneck factor based on the parameters configured when the BS is first installed and the information for determination of QoE bottleneck. In this case, the MN-CU 210 may not receive the policy related to determination of QoE bottleneck factor in operations 310 and 320. The parameters configured when the BS is first installed may include information required to determine whether information 370 for determination of QoE bottleneck received from the MN-DU 211 and/or the SN-DU 221 meets a certain condition, e.g., information about a RAN measurement object, a threshold, a timer, etc. For example, the MN-CU 210 may determine whether a sum of queuing delay values included in the information for determination of QoE bottleneck received from the MN-DU 211 and the SN-DU 221 becomes larger than a threshold set when the BS is first installed during a time of a certain timer, when the RAN measurement object included in the parameters configured when the BS is first installed is the buffer queuing delay. When the sum of queuing delay values included in the information for determination of QoE bottleneck received from the MN-DU 211 and the SN-DU 221 becomes larger than the threshold set when the BS is first installed during the time of the certain timer, the MN-CU 210 may determine that the QoE bottleneck factor is overflow.

The MN-CU 210 may determine a QoE bottleneck factor based on the policy related to determination of a QoE bottleneck factor and information for determination of QoE bottleneck received from the CN 200. For example, the MN-CU 210 may determine whether a sum of queuing delay values included in the information for determination of QoE bottleneck received from the MN-DU 211 and the SN-DU 221 becomes larger than a predefined threshold during a certain timer time, when the RAN measurement object included in the policy related to determination of a QoE bottleneck factor is buffer queuing delay. When the sum of queuing delay values included in the information for determination of QoE bottleneck received from the MN-DU 211 and the SN-DU 221 becomes larger than the predefined threshold during the certain timer time, the MN-CU 210 may determine that the QoE bottleneck factor is overflow.

Specific examples of how to determine each QoE bottleneck factor according to embodiments of the disclosure are described below with respect to FIG. 6.

In operation 390, the MN-CU 210 may perform QoE control based on the QoE bottleneck factor determined in operation 380. A QoE control operation for each QoE bottleneck factor will be described in detail in connection with FIG. 6.

In operations 310 to 390, in the wireless communication system that supports dual connectivity, the MN-CU may enhance QoE of the user by evaluating QoE, determining a QoE bottleneck factor, and performing an optimized QoE control operation for each QoE bottleneck factor.

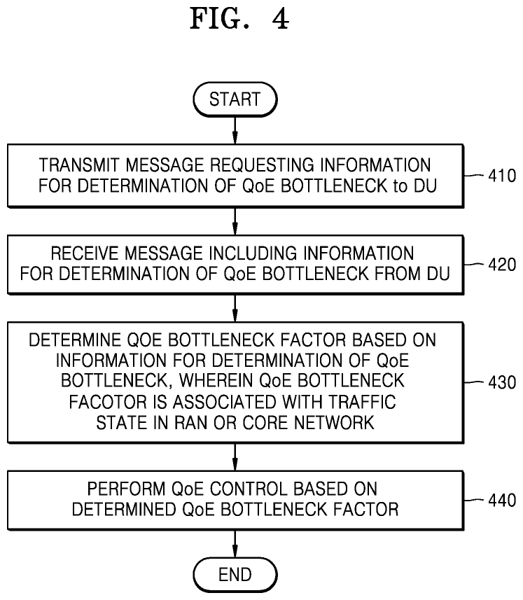

FIG. 4 is a flowchart for describing a method by which a CU controls QoE in a wireless communication system that supports dual connectivity, according to an embodiment of the disclosure.

Referring to FIG. 4, portions overlapping what is described in connection with FIG. 3 will not be described again.

Referring to FIG. 4, in operation 410, the CU may transmit, to the DU, a message requesting information for determination of QoE bottleneck. Operation 410 may correspond to operation 360 of FIG. 3.

In operation 420, the CU may receive, from the DU, a message including information for determination of QoE bottleneck. Operation 420 may correspond to operation 370 of FIG. 3.

In operation 430, the CU may determine a QoE bottleneck factor based on the received information for determination of QoE bottleneck. The QoE bottleneck factor is associated with a traffic state in a RAN or a core network. Operation 430 may correspond to operation 380 of FIG. 3.

In operation 440, the CU may perform QoE control based on the determined QoE bottleneck factor. Operation 440 may correspond to operation 390 of FIG. 3.

The CU may be an MN-CU or an SN-CU in the wireless communication system that supports dual connectivity, and the DU may be an MN-DU or an SN-DU in the wireless communication system that supports dual connectivity.

In operations 410 to 440, in the wireless communication system that supports dual connectivity, the CU may enhance QoE of the user by evaluating QoE, determining a QoE bottleneck factor, and performing an optimized QoE control operation for each QoE bottleneck factor.

FIG. 5 is a diagram for describing a method by which an MN-CU requests information for determination of QoE bottleneck, according to an embodiment of the disclosure.

Referring to FIG. 5, a message 510 requesting information for determination of QoE bottleneck may specify at least one piece of information for determination of QoE bottleneck, in operation 511. According to an embodiment of the disclosure, the MN-CU 210 may transmit, to the MN-DU 211 and/or the SN-DU 221, a request to transmit at least a piece of certain information for determination of QoE bottleneck. For example, the at least one piece of certain information for determination of QoE bottleneck may correspond to RLC BO, TBS, SP, or queuing delay.

A message 520 including the information for determination of QoE bottleneck may include information specified in the request message that specifies at least one piece of information for determination of QoE bottleneck, in operation 521. In an embodiment of the disclosure, the MN-DU 211 and/or the SN-DU 221 may transmit, to the MN-CU 210, a message including at least one piece of information specified in the request message, in response to the received message requesting information for determination of QoE bottleneck. The MN-DU 211 and/or the SN-DU 221 may transmit, to the MN-CU 210, the at least one piece of information for determination of QoE bottleneck specified when there is such a request message.

The message 510 requesting information for determination of QoE bottleneck may indicate to activate or deactivate at least one piece of information for determination of QoE bottleneck, in operation 512. According to an embodiment of the disclosure, the MN-CU 210 may request the MN-DU 211 and/or SN-DU 221 to include (activate) or not include (deactivate) at least one piece of information for determination of QoE bottleneck in a certain message to be periodically transmitted by the MN-DU 211 and/or SN-DU 221 to the MN-CU 210. The MN-CU 210 may deactivate certain information when the certain information is not required, and may reduce overhead of constantly measuring and reporting additional information for QoE determination with the activation and deactivation. The at least one piece of information for determination of QoE bottleneck may correspond to RLC BO, TBS, SP or queuing delay.

The message 520 including information for determination of QoE bottleneck may include activated information for determination of QoE bottleneck, in operation 522. According to an embodiment of the disclosure, the MN-DU 211 and/or SN-DU 221 may add the information for which activation is indicated in the received message requesting information for determination of bottleneck to a certain message to be periodically transmitted to the MN-CU 210.

The message 510 requesting information for determination of QoE bottleneck of FIG. 5 may correspond to the message 360 of FIG. 3 or the message 410 of FIG. 4. The message 520 including information for determination of QoE bottleneck of FIG. 5 may correspond to the message 370 of FIG. 3 or the message 420 of FIG. 4.

FIG. 6 is a diagram for describing an operation of an MN-CU controlling QoE based on a determined QoE bottleneck factor in detail, according to an embodiment of the disclosure.

Referring to FIG. 6, the MN-CU 210 may determine the QoE bottleneck factor to be one of the following cases:
CASE 1, unbalanced flow 610

The unbalanced flow 610 means that amounts of traffic distributed by the PDCP of the MN-CU 210 and coming into the MN-DU 211 and the SN-DU 221 are unbalanced. For example, as shown in FIG. 6, the unbalanced flow may correspond to a case that a noticeably larger amount of traffic comes into the RLC of the MN-DU 211 than into the RLC of the SN-DU 221. For example, the MN-CU 210 may determine that a QoE bottleneck factor is the unbalance 610 according to Equation 2. Equation 2 may be an example of a standard for determining that the QoE bottleneck factor is the unbalance 610, and may be included in the policy related to determination of a QoE bottleneck factor or configured with an invariable value when the BS is first installed.

$$\vert \frac{{BO}_{MN}}{{SP}_{MN} \cdot {TBS}_{MN}} - \frac{{BO}_{SN}}{{SP}_{SN} \cdot {TBS}_{SN}} \vert > {TH}_{unbalance} \qquad Equation 2$$

In Equation 2, BO_{MN} is a value indicating data queued in an RLC buffer of the MN-DU 211 in bytes, SP_{MN} is a value indicating the number of times that an MAC scheduler of the MN-DU 211 schedules the DRB for a unit time, TBS_{MN} is a value indicating an average TBS value in bytes in the DRB of the MN-DU 211, BO_{SN} is a value indicating data queued in an RLC buffer of the SN-DU 221 in bytes, SPAN is a value indicating the number of times that an MAC scheduler of the SN-DU 221 schedules the DRB for a unit time, and TBS_{SN} is a value indicating an average TBS value in bytes in the DRB of the SN-DU 221.

According to an embodiment of the disclosure, the MN-CU 210 may receive, from the MN-DU 211 (or the SN-DU 221), each queuing delay value Q_{delay,MN} (or Q_{delay,SN}) alone, as information for determination of QoE bottleneck. In an embodiment of the disclosure, the MN-CU 210 may receive a value of combination of at least one of BO_{MN}, TBS_{MN}, SP_{MN} values (or BO_{SN}, TBS_{SN}, SP_{SN} values) as information for determination of QoE bottleneck and estimate the queuing delay value Q_{delay,MN} (or Q_{delay,SN}). For example, the MN-CU 210 may receive a value of SP_{MN}*TBS_{MN}=R_{MN} (or value of SP_{SN}*TBS_{SN}=R_{SN}) alone, which is defined as a parameter referred to as a link data rate as information for determination of QoE bottleneck or receive it with a value of BO_{MN} (or BO_{SN}) to estimate a queuing delay value Q_{delay,MN} (or Q_{delay,SN}).

TH_{unbalance} is a threshold related to the unbalanced flow 610 among QoE bottleneck factors, and refers to a threshold to be compared with a difference in queuing delay value or estimated queuing delay value of the MN-DU 211 and SN-DU 221 when the MN-CU 210 determines that the QoE bottleneck factor is the unbalance 610. TH_{unbalance} may be included in the policy related to determination of QoE bottleneck factor, or set to an invariable value when the BS is first installed.

The MN-CU 210 may compare the difference in queuing delay value or estimated queuing delay value estimated based on the information for determination of QoE bottleneck received from the MN_DU 211 and the SN-DU 221 with the threshold TH_{unbalance} according to Equation 2, and when the difference is larger than the threshold TH_{unbalance}, determine that the QoE bottleneck factor is the unbalance 610.

The MN_CU 210 may adjust a split ratio of the PDCP in operation 611, when the determined QoE bottleneck factor is the unbalance 610. The MN-CU 210 may transmit data to the MN-DU 211 and/or the SN-DU 221 according to the adjusted split ratio of the PDCP, in operation 612. Operations 611 and 612 may be referred to as a traffic steering procedure or a traffic offloading procedure, which is to make the most of diversity gains of multiple paths when a node on one side is degraded.
CASE 2, overflow 620

The overflow 620 refers to a state in which buffer overflow occurs due to excessive traffic transmission of a CN (e.g., a user plane function (UPF)). For example, as shown in FIG. 6, the overflow 620 may correspond to a case that an excessively large amount of traffic comes into the RLC of the MN-DU 211 and the RLC of the SN-DU 221. For example, the MN-CU 210 may determine that a QoE bottleneck factor is the overflow 620 according to Equation 3. Equation 3 may be an example of a standard for determining that the bottleneck factor is the overflow 620, and may be included in a policy related to determination of a QoE bottleneck factor or configured with an invariable value when the BS is first installed.

$$\frac{{BO}_{MN}}{{SP}_{MN} \cdot {TBS}_{MN}} + \frac{{BO}_{SN}}{{SP}_{SN} \cdot {TBS}_{SN}} > {TH}_{overflow} \qquad Equation 3$$

In Equation 3, BO_{MN} is a value indicating data queued in an RLC buffer of the MN-DU 211 in bytes, SP_{MN} is a value indicating the number of times that an MAC scheduler of the MN-DU 211 schedules the DRB for a unit time, TBS_{MN} is a value indicating an average TBS value in bytes in the DRB of the MN-DU 211, BO_{SN} is a value indicating data queued in an RLC buffer of the SN-DU 221 in bytes, SPAN is a value indicating the number of times that an MAC scheduler of the SN-DU 221 schedules the DRB for a unit time, and TBS_{SN} is a value indicating an average TBS value in bytes in the DRB of the SN-DU 221.

According to an embodiment of the disclosure, the MN-CU 210 may receive, from the MN-DU 211 (or the SN-DU 221), each queuing delay value Q_{delay,MN} (or Q_{delay,SN}) alone, as information for determination of QoE bottleneck. According to another embodiment of the disclosure, the MN-CU 210 may receive a value of combination of at least one of BO_{MN}, TBS_{MN}, SP_{MN} values (or BO_{SN}, TBS_{SN}, SP_{SN} values) as information for determination of QoE bottleneck and estimate the queuing delay value Q_{delay,MN} (or Q_{delay,SN}). For example, the MN-CU 210 may receive a value of SP_{MN}*TBS_{MN}=R_{MN} (or value of SP_{SN}*TBS_{SN}=R_{SN}) alone, which is defined as a parameter referred to as a link data rate as information for determination of QoE bottleneck or receive it with a value of BO_{MN} (or BO_{SN}) to estimate a queuing delay value Q_{delay,MN} (or Q_{delay,SN}).

TH_{overflow} is a threshold related to the overflow 620 among QoE bottleneck factors, and refers to a threshold to be compared with a sum of queuing delay values or estimated queuing delay values of the MN-DU 211 and SN-DU 221 when the MN-CU 210 determines that the QoE bottleneck factor is the overflow 620. TH_{overflow} may be included in the policy related to determination of QoE bottleneck factor, or set to an invariable value when the BS is first installed.

The MN-CU 210 may compare the sum of queuing delay values or estimated queuing delay values estimated based on the information for determination of QoE bottleneck received from the MN_DU 211 and the SN-DU 221 with the threshold TH_{overflow} according to Equation 3, and when the sum is larger than the threshold TH_{overflow}, determine that the QoE bottleneck factor is the overflow 620.

According to an embodiment of the disclosure, the MN-CU 210 may report a network condition to an application function (AF) through a network exposure function (NEF) to adjust amounts of traffic coming in from an application server when the determined QoE bottleneck factor is the overflow 620.

The MN-CU 210 may transmit a message for decreasing quality of service (QoS) to a CN (e.g., a session management function (SMF)) in operation 621 to reduce the traffic coming into the RAN from a UPF of the CN when the determined QoE bottleneck factor is the overflow 620. Examples of a variable QoS-related parameter include a guaranteed flow bitrate (GFBR), a 5G QoS identifier (5QI), an allocation and retention priority (ARP) or the like, without being limited thereto. The MN-CU 210 may deliver information about parameters related to a QoS flow ID (QFI) and QoS desired to be changed in the message for decreasing QoS. The MN-CU 210 may directly deliver the information for determining QoE bottleneck and the QFI in the message for decreasing QoS, and in this case, configure a parameter related to QoS to be changed based on the information for determining QoE bottleneck and the QFI received by the CN.

The MN-CU 210 may perform a protocol data unit (PDU) session modification procedure by interacting with the CN, in operation 622.

The MN-CU 210 may transmit information about reduced QoS (a QoS profile) to the MN-DU 211 and/or the SN-DU 221, and the MN-DU 211 and/or the SN-DU 221 may use the received information to an MAC scheduler, in operation 623. The MN-CU 210 may transmit information about the reduced QoS in a new F1-U message or an existing DL USER DATA field.

Operations 621 to 623 may be referred to as a QoS change procedure to enhance traffic throttling, which may operate similarly to an algorithm for the MN-DU 211 or the SN-DU 221 to control its buffer overflow. Hence, in the disclosure, a case that is not able to control overflow with the existing overflow control algorithm may get better by determining the overflow based on buffer states of two DUs involved in dual connectivity instead of a buffer state of one DU.
CASE 3, underflow 630

The underflow 630 refers to a state in which buffer underflow occurs due to slower traffic transmission of a CN (e.g., UPF) than that of a radio link. For example, as shown in FIG. 6, the underflow 630 may correspond to a case that a significantly small amount of traffic comes into the RLC of the MN-DU 211 and the RLC of the SN-DU 221. For example, the MN-CU 210 may determine that a QoE bottleneck factor is the underflow 630 according to Equation 4. Equation 4 may be an example of a standard for determining that the bottleneck factor is the underflow 630, and may be included in the policy related to determination of a QoE bottleneck factor or configured with an invariable value when the BS is first installed.

$$\frac{{BO}_{MN}}{{SP}_{MN} \cdot {TBS}_{MN}} + \frac{{BO}_{SN}}{{SP}_{SN} \cdot {TBS}_{SN}} < {TH}_{underflow} \qquad Equation 4$$

In Equation 4, BO_{MN} is a value indicating data queued in an RLC buffer of the MN-DU 211 in bytes, SP_{MN} is a value indicating the number of times that an MAC scheduler of the MN-DU 211 schedules the DRB for a unit time, TBS_{MN} is a value indicating an average TBS value in bytes in the DRB of the MN-DU 211, BO_{SN} is a value indicating data queued in an RLC buffer of the SN-DU 221 in bytes, SP_{SN} is a value indicating the number of times that an MAC scheduler of the SN-DU 221 schedules the DRB for a unit time, and TBS_{SN} is a value indicating an average TBS value in bytes in the DRB of the SN-DU 221.

According to an embodiment of the disclosure, the MN-CU 210 may receive, from the MN-DU 211 (or the SN-DU 221), each queuing delay value Q_{delay,MN} (or Q_{delay,SN}) alone, as information for determination of QoE bottleneck. According to another embodiment of the disclosure, the MN-CU 210 may receive a value of combination of at least one of BO_{MN}, TBS_{MN}, SP_{MN} values (or BO_{SN}, TBS_{SN}, SP_{SN} values) as information for determination of QoE bottleneck and estimate the queuing delay value Q_{delay,MN} (or Q_{delay,SN}). For example, the MN-CU 210 may receive a value of SP_{MN}*TBS_{MN}=R_{MN} (or value of SP_{SN}*TBS_{SN}=R_{SN}) alone, which is defined as a parameter referred to as a link data rate as information for determination of QoE bottleneck or receive the value along with a value of BO_{MN} (or BO_{SN}) to estimate a queuing delay value Q_{delay,MN} (or Q_{delay,SN}).

TH_{underflow} is a threshold related to the underflow 630 among QoE bottleneck factors, and refers to a threshold to be compared with a sum of queuing delay values or estimated queuing delay values of the MN-DU 211 and SN-DU 221 when the MN-CU 210 determines that the QoE bottleneck factor is the underflow 630. TH_{underflow} may be included in a policy related to determination of QoE bottleneck factor, or set to an invariable value when the BS is first installed.

The MN-CU 210 may compare the sum of queuing delay values or estimated queuing delay values estimated based on the information for determination of QoE bottleneck received from the MN_DU 211 and the SN-DU 221 with the threshold TH_{underflow} according to Equation 4, and when the sum is smaller than the threshold TH_{underflow}, determine that the QoE bottleneck factor is the underflow 630.

The MN-CU 210 may report a network condition to an AF through an NEF to adjust amounts of traffic coming in from the application server when the determined QoE bottleneck factor is the underflow 630.

The MN-CU 210 may transmit a message for increasing QoS to a CN (e.g., an SMF) in operation 631 to increase traffic coming into the RAN from a UPF of the CN when the determined QoE bottleneck factor is the underflow 630. There is a GFBR, a 5GI, an ARP or the like as an example of a variable QoS-related parameter, without being limited thereto. In an embodiment of the disclosure, the MN-CU 210 may deliver information about parameters related to a QFI and QoS desired to be changed in the message for increasing QoS. In an embodiment of the disclosure, the MN-CU 210 may directly deliver the information for determining QoE bottleneck and the QFI in the message for increasing QoS, and in this case, configure a parameter related to QoS to be changed based on the information for determining QoE bottleneck and the QFI received by the CN.

The MN-CU 210 may perform a PDU session modification procedure by interacting with the CN, in operation 632.

The MN-CU 210 may transmit information about increased QOS (a QoS profile) to the MN-DU 211 and/or the SN-DU 221, and the MN-DU 211 and/or the SN-DU 221 may use the received information in the MAC scheduler, in operation 633. In an embodiment of the disclosure, the MN-CU 210 may transmit information about the increased QoS in a new F1-U message or an existing DL USER DATA field.

Operations 631 to 633 may be referred to as a QoS change procedure to relieve traffic throttling, which may operate similarly to an algorithm for the MN-DU 211 or the SN-DU 221 to control its buffer underflow. Hence, in the disclosure, a case that is not able to control underflow with the existing underflow control algorithm may get better by determining the underflow based on buffer states of two DUs involved in dual connectivity instead of a buffer state of one DU.

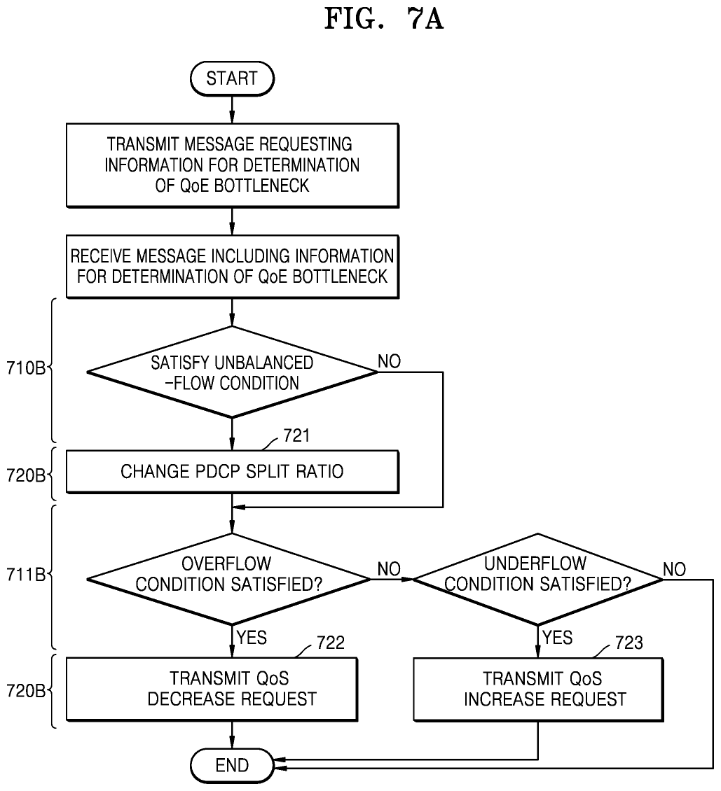

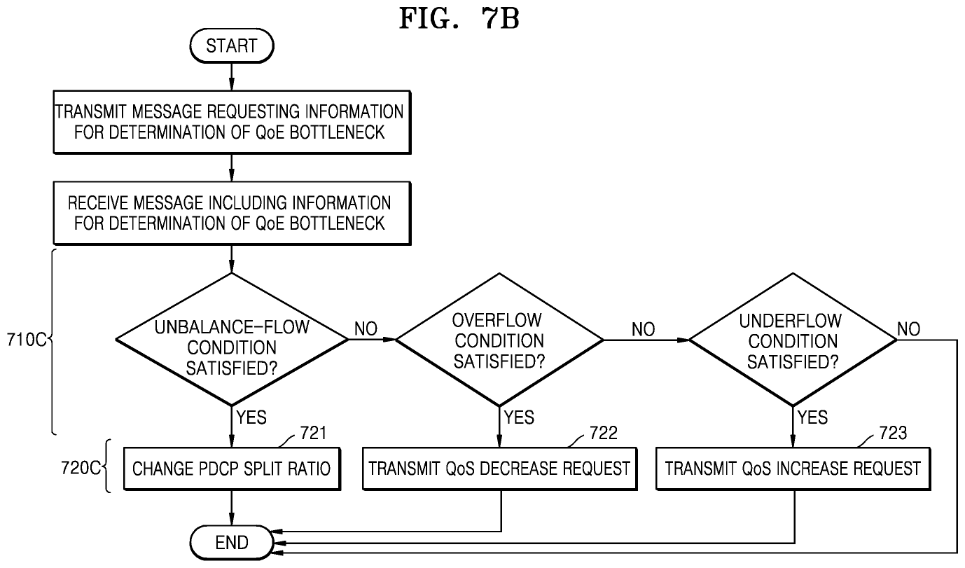

FIGS. 7A and 7B are diagrams for describing how an MN-CU determines a QoE bottleneck factor, according to various embodiments of the disclosure.

Referring to FIGS. 7A and 7B, shown are various embodiments of the disclosure according to how to determine conditions (610, 620 and 630 of FIG. 6) of QoE bottleneck factors. Portion overlapping what is described in connection with FIGS. 3 and 4 will not be described again.

According to an embodiment of the disclosure, which method of determining a QoE bottleneck factor as shown in FIGS. 7A and 7B will be used by the MN_CU to determine a QoE bottleneck factor may be determined by the MN-CU's own configuration, and the configuration may be performed based on a policy related to determination of QoE bottleneck factor received from the CN.

Referring to FIG. 7A, the MN-CU 210 may determine a QoE bottleneck factor by first determining whether the unbalance condition 610 is satisfied in operation 710B, then determine whether the overflow condition 620 is satisfied in operation 711B, and when the overflow condition 620 is not satisfied, determining whether the underflow condition 630 is satisfied.

Order of the conditions 610, 620 and 630 to determine a QoE bottleneck factor determined in operations 710B and 711B may be changed. For example, the MN-CU 210 may determine a QoE bottleneck factor by first determining whether the unbalance condition 610 is satisfied in operation 710B, then determining whether the underflow condition 630 is satisfied in operation 711B, and when the underflow condition 630 is not satisfied, determining whether the overflow condition 620 is satisfied. For example, the MN-CU 210 may determine a QoE bottleneck factor by first determining whether the overflow condition 620 and the underflow condition 630 are satisfied in parallel or simultaneously in operation 710B and determining whether the unbalance condition 610 is satisfied in operation 711B.

The order of determining the conditions may be determined by the MN-CU 210 according to its own configuration or configured based on a policy related to determination of a QoE bottleneck factor received from the CN.

In operation 720B, when both the unbalance condition 610 and the overflow condition 620 are satisfied, the MN-CU 210 may perform network optimization operations 721 and 722 corresponding to the respective conditions in parallel or simultaneously. When both the unbalance condition 610 and the underflow condition 630 are satisfied, the MN-CU 210 may perform network optimization operations 721 and 723 corresponding to the respective conditions in parallel or simultaneously.

Referring to FIG. 7B, in operation 710C, the MN-CU 210 may determine a QoE bottleneck factor by sequentially determining whether conditions of the unbalance 610, the overflow 620 and the underflow 630 are satisfied. Order of determining the conditions of the unbalance 610, the overflow 620 and the underflow 630 may be changed. In an embodiment of the disclosure, the order of determining the conditions may be determined by the MN-CU 210 according to its own configuration or configured based on a policy related to determination of a QoE bottleneck factor received from the CN.

In operation 720C, the MN-CU 210 may perform a procedure among the network optimization operations 721, 722 and 723 corresponding to the respective conditions of the unbalance 610, the overflow 620 and the underflow 630. For example, when the unbalance condition 610 (or the overflow condition 620 or the underflow condition 630) is satisfied, the MN-CU 210 may perform the network optimization operation 721, 722 or 723 corresponding to the unbalance condition 610 without determining the other conditions.

The network optimization operations 721, 722 and 723 of FIGS. 7A and 7B may correspond to operation 390 of FIG. 3 and operation 440 of FIG. 4.

Referring to FIGS. 7A and 7B, the MN-CU in the wireless communication system that supports dual connectivity may determine a QoE bottleneck factor by determining a condition of the QoE bottleneck factor in various ways, thereby performing an accurate QoE control operation depending on the condition and eventually, enhancing QoE of the user.

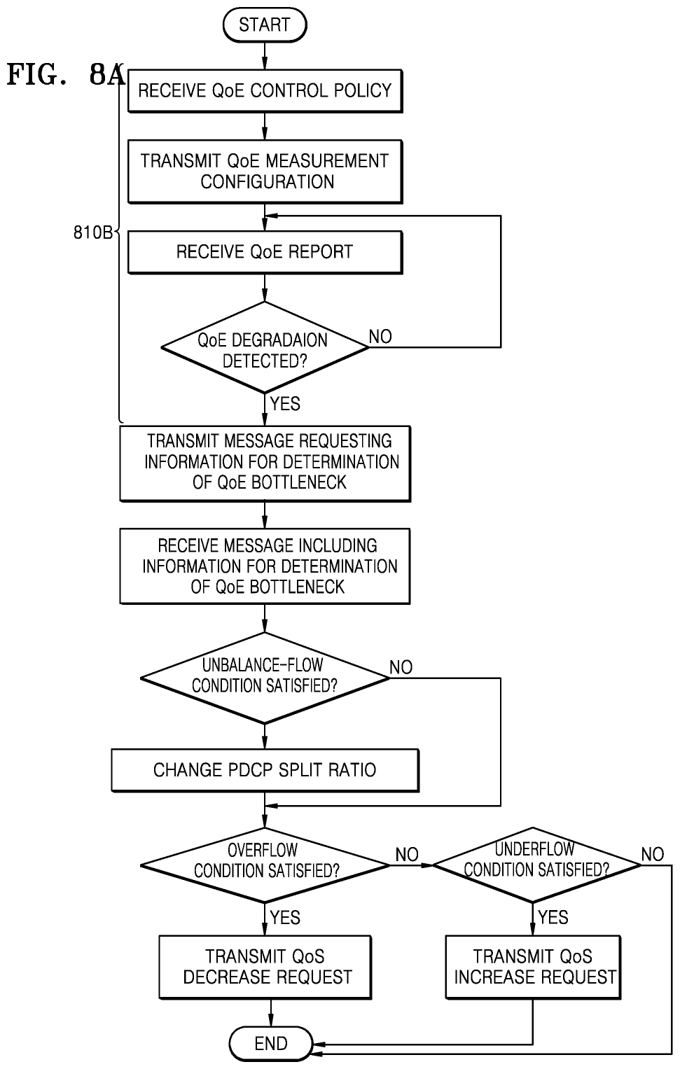

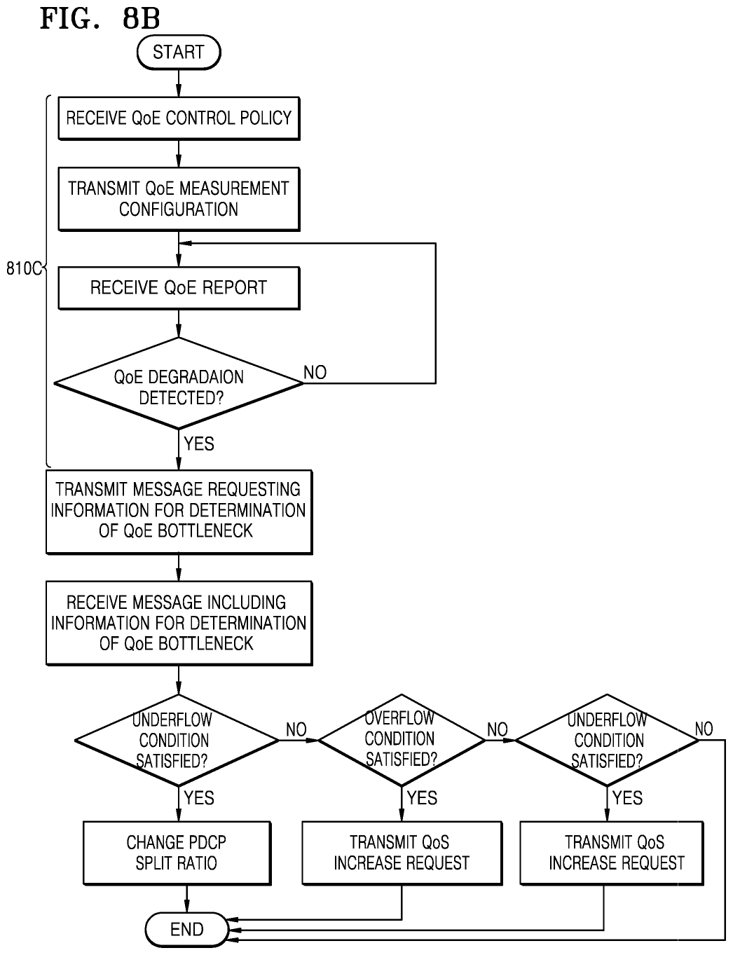

FIGS. 8A and 8B are diagrams for describing a procedure in which an MN-CU transmits a message requesting information for determination of QoE bottleneck based on a QoE evaluation result, according to various embodiments of the disclosure.

Referring to FIGS. 8A and 8B, shown is a flowchart of an occasion when various embodiments of the disclosure are triggered based on a QoE evaluation procedure depending on the method of determining the QoE bottleneck factor conditions 610, 620 and 630 as shown in FIGS. 7A and 7B.

In operation 810B of FIG. 8A, the MN-CU may receive a QoE control policy. The MN-CU may transmit a QoE measurement configuration to the UE, and in return for this, may receive a QoE report from the UE. The MN-CU may detect QoE degradation based on the QoE control policy and the QoE report. The method of controlling QoE shown in FIG. 7A may be triggered based on operation 810A.

Similarly, referring to FIG. 8B, the method of controlling QoE as shown in FIG. 7B may be triggered based on operation 810C.

Operations 810B and 810C of FIGS. 8A and 8B may correspond to operations 320 to 350 of FIG. 3.

Among what are shown in FIGS. 8A and 8B, portions overlapping what is described in connection with FIGS. 3, 4, 7A, and 7B will not be described again.

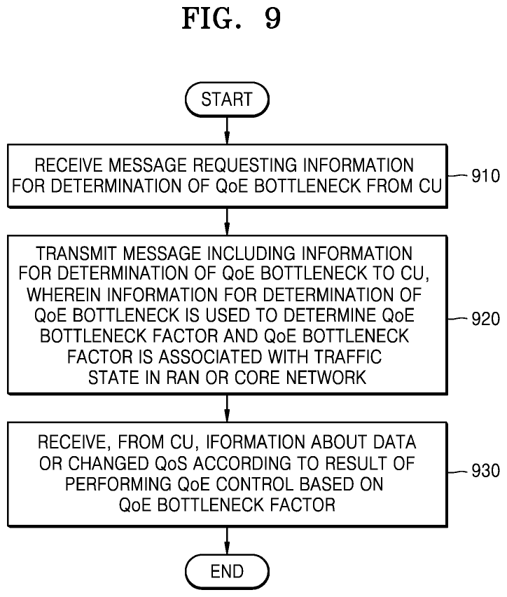

FIG. 9 is a flowchart for describing a method by which a DU controls QoE in a wireless communication system that supports dual connectivity, according to an embodiment of the disclosure.

Referring to FIG. 9, in operation 910, the DU may receive, from the CU, a message requesting information for determination of QoE bottleneck.

In operation 920, the DU may transmit, to the CU, a message including the information for determination of QoE bottleneck. The information for determination of QoE bottleneck may be used by the CU to determine a QoE bottleneck factor. The QoE bottleneck factor is associated with a traffic state in a RAN or a CN.

In operation 930, the DU may receive, from the CU, data or information about changed QoS as a result of the CU performing QoE control based on the QoE bottleneck factor.

The CU may be an MN-CU or an SN-CU in the wireless communication system that supports dual connectivity, and the DU may be an MN-DU or an SN-DU in the wireless communication system that supports dual connectivity.

Operations 910 to 930 may operate similarly to the embodiments described above. In operations 910 to 930, in the wireless communication system that supports dual connectivity, the DU may provide the CU with information for determination of QoE bottleneck required to perform a QoE control operation for each QoE bottleneck factor, and eventually, contribute to enhancement of QoE of the user.

FIGS. 10A and 10B are diagrams for describing an SN terminated split bearer structure and a method of controlling QoE in the SN terminated split bearer structure, according to various embodiments of the disclosure.

FIG. 10A shows an SN terminated split bearer structure in which a PDCP is used in the SN as a split bearer scheme in a wireless communication system that supports dual connectivity, and FIG. 10B shows a method by which the SN-CU 220 controls QoE in the SN terminated split bearer structure.

Referring to FIG. 10A, the PDCP belonging to the SN-CU 220 may serve to distribute traffic coming into the RLC of the MN-DU 211 and the RLC of the SN-DU 221 (where the SN-CU 220, the MN-DU 211 and the SN-DU 221 may be included in the NG-RAN 100 of FIG. 1).

Referring to FIG. 10B, the method by which the SN-CU 220 controls QoE in the SN terminated split bearer structure may operate similarly to the method by which the MN-CU 210 controls QoE in the MN terminated split bearer structure as described above in the disclosure.

However, the SN-CU 220 may transmit and receive signals to and from the core network 200 not directly but through the MN-CU 210. For example, the SN-CU 220 may receive, from the core network (or CN) 200, a QoE control policy through an Xn interface 1010 with the MN-CU 210. Furthermore, the SN-CU 220 may transmit, to the core network 200, a message for decreasing/increasing QoS through the Xn interface 1010 with the MN-CU 210. The Xn interface 1010 refers to an interface between BSs (e.g., gNBs) in a wireless communication system.

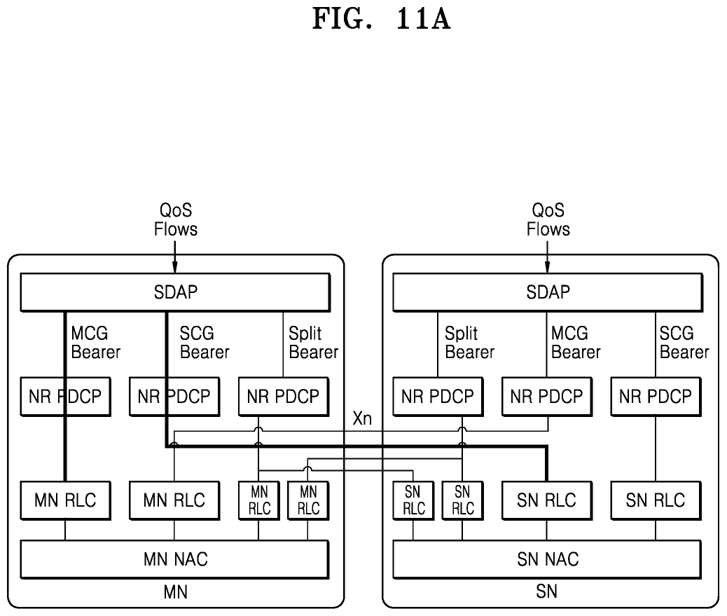

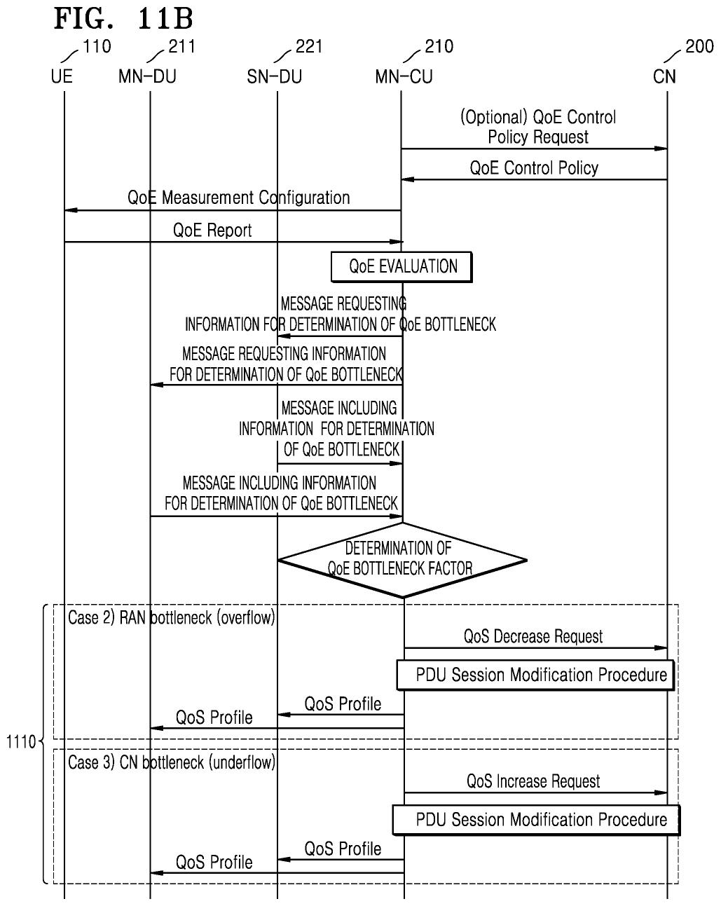

FIGS. 11A and 11B are diagrams for describing an MN terminated MCG SCG bearer structure and a method of controlling QoE in the MN terminated MCG SCG bearer structure, according to various embodiments of the disclosure.

FIG. 11A shows an MN terminated MCG SCG bearer structure in which a PDCP is used in the MN in a wireless communication system that supports dual connectivity and FIG. 11B shows a method by which the MN-CU 210 controls QoE in the MN terminated MCG SCG bearer structure.

Referring to FIG. 11A, in a case of multi-modal traffic, one QoS flow may be split into an MCG bearer and an SCG bearer in an MN. The multi-modal traffic refers to traffic in which various types of sensory data, such as an image, voice, haptic data, etc., are mixed. Hence, in the case of multi-modal traffic, various types of sensory data may be allocated to different bearers. Examples of the multi-modal traffic include extended reality (XR) traffic. XR may be the generic term for virtual reality (VR), augmented reality (AR) and mixed reality (MR). In the next generation wireless communication system, a significant amount of XR traffic is expected to be handled for various applications such as a mobile media service, a cloud game, a video based remote control, interaction-based automation, etc. The XR traffic has a characteristic to require short latency, high throughput and high reliability, and needs to satisfy QoE of the user along with extension of battery life and low power consumption for user convenience. The disclosure provides a method by which the MN-CU controls QoE for each QoE bottleneck factor to enhance QoE of the user in the wireless communication system that supports dual connectivity in the case of multi-modal traffic, i.e., in the case that various types of sensory data are allocated to the MCG bearer and the SCG bearer.

Referring to FIG. 11B, the method by which the MN-CU 210 controls QoE in the MN terminated MCG SCG bearer structure may operate similarly to the method by which the MN-CU 210 controls QoE in the MN terminated split bearer structure as described above in the disclosure.

However, as in operation 1110 of FIG. 11B, the unbalance state 610 among the QoE bottleneck factors may not be applied to the MN terminated MCG SCG bearer structure, and accordingly, the MN-CU 210 may not perform a traffic offloading procedure through PDCP split ratio adjustment among QoE control operations in the MN terminated MCG SCG bearer structure.

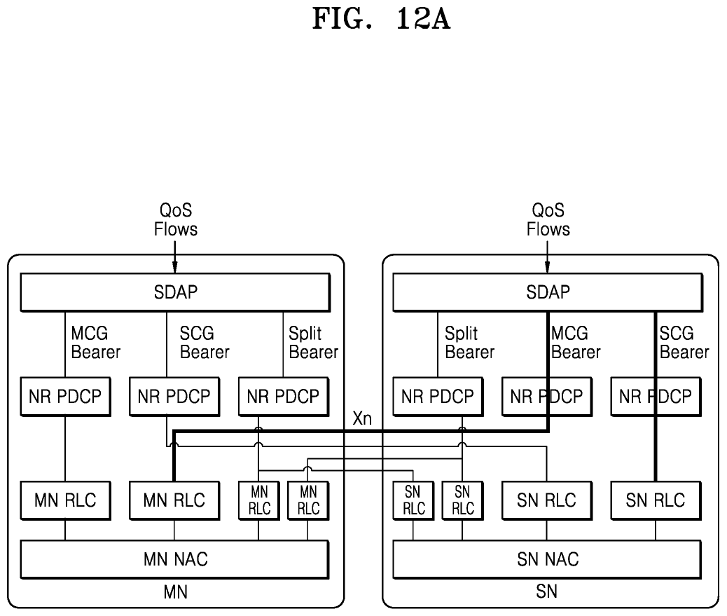

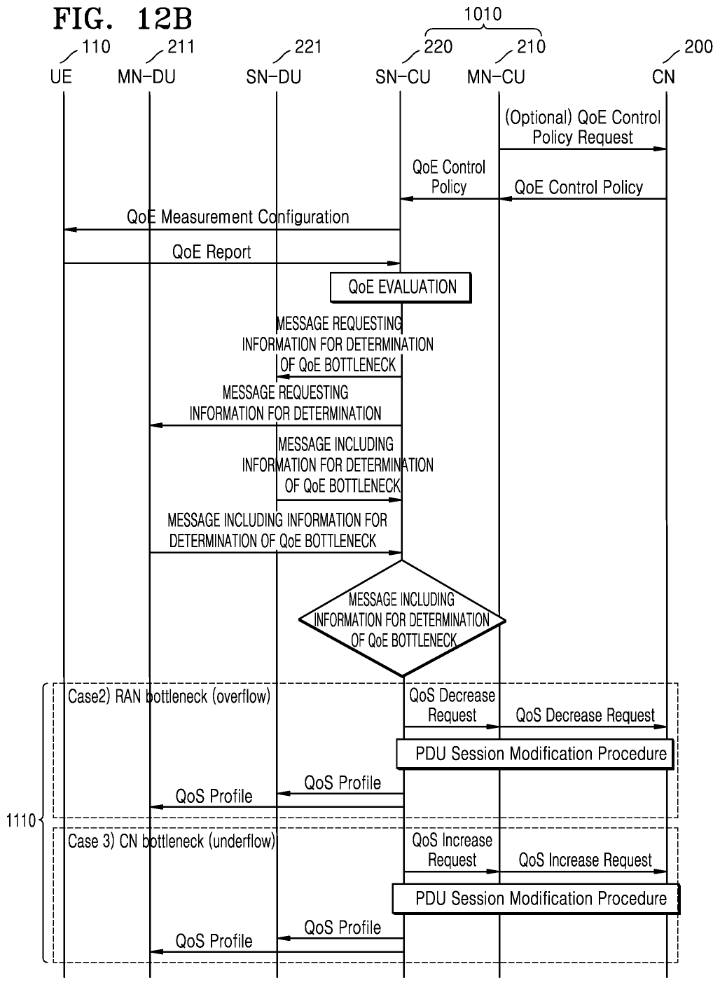

FIGS. 12A and 12B are diagrams for describing an SN terminated MCG SCG bearer structure and a method of controlling QoE in the SN terminated MCG SCG bearer structure, according to various embodiments of the disclosure.

FIG. 12A shows an SN terminated MCG SCG bearer structure in which a PDCP is used in the SN in a wireless communication system that supports dual connectivity and FIG. 12B shows a method by which the SN-CU 220 controls QoE in the SN terminated MCG SCG bearer structure.

Referring to FIG. 12A, in a case of multi-modal traffic, one QoS flow may be split into an MCG bearer and an SCG bearer in an SN. The disclosure provides a method by which the SN-CU controls QoE for each QoE bottleneck factor to enhance QoE of the user in the wireless communication system that supports dual connectivity in the case of multi-modal traffic, i.e., in the case that various types of sensory data are allocated to the MCG bearer and the SCG bearer.

Referring to FIG. 12B, the method by which the SN-CU 220 controls QoE in the SN terminated MCG SCG bearer structure may operate similarly to the method by which the SN-CU 220 controls QoE in the SN terminated split bearer structure as described above in the disclosure. In other words, the SN-CU 220 may transmit and receive signals to and from the core network 200 not directly but through the MN-CU 210. For example, the SN-CU 220 may receive, from the core network 200, a QoE control policy through the Xn interface 1010 with the MN-CU 210. Furthermore, the SN-CU 220 may transmit, to the core network 200, a message for decreasing/increasing QoS through the Xn interface 1010 with the MN-CU 210.

However, as in operation 1110 of FIG. 12B, the unbalance state 610 among the QoE bottleneck factors may not be applied to the SN terminated MCG SCG bearer structure, and accordingly, the SN-CU 220 may not perform a traffic offloading procedure through PDCP split ratio adjustment among QoE control operations in the SN terminated MCG SCG bearer structure.

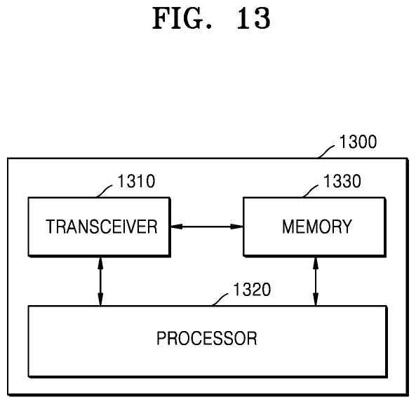

FIG. 13 is a block diagram of a CU, according to an embodiment of the disclosure.

Referring to FIG. 13, the CU 1300 may include a transceiver 1310, a processor 1320, and a memory 1330. The transceiver 1310, the processor 1320 and the memory 1330 of the CU 1300 may operate according to the aforementioned communication method of the CU 1300. Elements of the CU 1300 are not, however, limited thereto. For example, the CU 1300 may include more or fewer elements than described above. In addition, the transceiver 1310, the processor 1320, and the memory 1330 may be implemented in a single chip. The processor 1320 may include one or more processors.

The transceiver 1310 is a collective term of a receiver and a transmitter of the CU 1300, and may transmit or receive signals to or from a network entity including a DU 1400 or a UE. The signals to be transmitted to or received from the UE or the network entity including the DU 1400 may include control information and data. For this, the transceiver 1310 may include an RF transmitter for up-converting the frequency of a signal to be transmitted and amplifying the signal and an RF receiver for low-noise amplifying a received signal and down-converting the frequency of the received signal. It is merely an example of the transceiver 1310, and the elements of the transceiver 1310 are not limited to the RF transmitter and RF receiver.

The transceiver 1310 may perform functions for transmitting and receiving signals on a wireless channel. For example, the transceiver 1310 may receive a signal on a wireless channel and output the signal to the processor 1320, and transmit a signal output from the processor 1320 on a wireless channel.

The memory 1330 may store a program and data required for operation of the CU 1300. Furthermore, the memory 1330 may store control information or data included in a signal obtained by the CU 1300. The memory 1330 may include a storage medium such as a read only memory (ROM), a random-access memory (RAM), a hard disk, a compact disc ROM (CD-ROM), and a digital versatile disc (DVD), or a combination of storage mediums. Alternatively, the memory 1330 may not be separately present but integrated into the processor 1320. The memory 1330 may include a volatile memory, a non-volatile memory, or a combination of the volatile memory and the non-volatile memory. The memory 1330 may also provide the stored data at the request of the processor 1320.

The processor 1320 may control a series of processes for the CU 1300 to operate according to an embodiment of the disclosure. For example, the processor 1320 may receive control signals and data signals through the transceiver 1310 and process the received control signals and data signals. The processor 1320 may transmit the processed control signal and data signal through the transceiver 1310. The processor 1320 may record data to the memory 1330 or read out data from the memory 1330. The processor 1320 may perform functions of a protocol stack requested by a communication standard. For this, the processor 1320 may include at least one processor or microprocessor. In an embodiment of the disclosure, part of the transceiver 1310 and the processor 1320 may be referred to as a CP.

The processor 1320 may include one or more processors. The one or more processors may include a universal processor such as a CPU, an AP, a digital signal processor (DSP), etc., a GPU, a vision processing unit (VPU), etc., or a dedicated AI processor such as a neural processing unit (NPU). For example, when the one or more processors are the dedicated AI processors, the dedicated AI processors may be designed in a hardware structure that is specific to dealing with a particular AI model.

In an embodiment of the disclosure, the processor 1320 may transmit, to the DU 1400, a message requesting information for determination of QoE bottleneck. The processor 1320 may also receive, from the DU 1400, a message including information for determination of QoE bottleneck. The processor 1320 may determine a QoE bottleneck factor based on the received information for determination of QoE bottleneck. The processor 1320 may perform QoE control based on the determined QoE bottleneck factor.

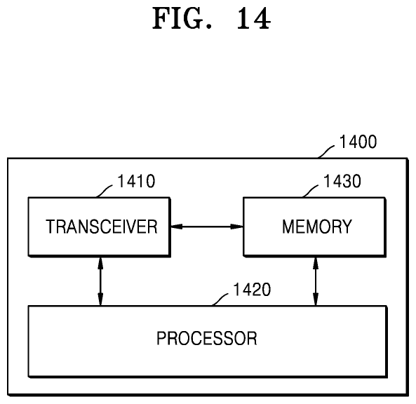

FIG. 14 is a block diagram of the DU 1400, according to an embodiment of the disclosure.

Referring to FIG. 14, the DU 1400 may include a transceiver 1410, a processor 1420, and a memory 1430. The transceiver 1410, the processor 1420 and the memory 1430 of the DU 1400 may operate according to the aforementioned communication method of the DU 1400. Elements of the DU 1400 are not, however, limited thereto. For example, the DU 1400 may include more or fewer elements than described above. In addition, the transceiver 1410, the processor 1420, and the memory 1430 may be implemented in a single chip. The processor 1420 may include one or more processors.

The transceiver 1410 is a collective term of a receiver and a transmitter of the DU 1400, and may transmit or receive signals to or from a network entity including a CU 1300 or a UE. The signals to be transmitted to or received from the UE or the network entity including the CU 1300 may include control information and data. For this, the transceiver 1410 may include an RF transmitter for up-converting the frequency of a signal to be transmitted and amplifying the signal and an RF receiver for low-noise amplifying a received signal and down-converting the frequency of the received signal. It is merely an example of the transceiver 1410, and the elements of the transceiver 1410 are not limited to the RF transmitter and RF receiver.

The transceiver 1410 may perform functions for transmitting and receiving signals on a wireless channel. For example, the transceiver 1410 may receive a signal on a wireless channel and output the signal to the processor 1420, and transmit a signal output from the processor 1420 on a wireless channel.

The memory 1430 may store a program and data required for operation of the DU 1400. Furthermore, the memory 1430 may store control information or data included in a signal obtained by the DU 1400. The memory 1430 may include a storage medium such as a ROM, a RAM, a hard disk, a CD-ROM, and a DVD, or a combination of storage mediums. Alternatively, the memory 1430 may not be separately present but integrated into the processor 1420. The memory 1430 may include a volatile memory, a non-volatile memory, or a combination of the volatile memory and the non-volatile memory. The memory 1430 may also provide the stored data at the request of the processor 1420.

The processor 1420 may control a series of processes for the DU 1400 to operate according to an embodiment of the disclosure. For example, the processor 1420 may receive control signals and data signals through the transceiver 1410 and process the received control signals and data signals. The processor 1420 may transmit the processed control signal and data signal through the transceiver 1410. The processor 1420 may record data to the memory 1430 or read out data from the memory 1430. The processor 1420 may perform functions of a protocol stack requested by a communication standard. For this, the processor 1420 may include at least one processor or microprocessor. In an embodiment of the disclosure, part of the transceiver 1410 and the processor 1420 may be referred to as a CP.

The processor 1420 may include one or more processors. The one or more processors may include a universal processor such as a CPU, an AP, a digital signal processor (DSP), etc., a GPU, a vision processing unit (VPU), etc., or a dedicated AI processor such as a neural processing unit (NPU). For example, when the one or more processors are the dedicated AI processors, the dedicated AI processors may be designed in a hardware structure that is specific to dealing with a particular AI model.

In an embodiment of the disclosure, the processor 1420 may receive, from the CU 1300, a message requesting information for determination of QoE bottleneck. The processor 1420 may also transmit, to the CU 1300, a message including information for determination of QoE bottleneck. The processor 1420 may receive, from the CU 1300, information about data or changed QoS as a result of performing QoE control based on the QoE bottleneck factor.

Specific examples for describing embodiments of the disclosure are merely a combination of one of standards, methods, detailed methods, and operations, and through a combination of two or more of the aforementioned schemes, the CU and the DU may control and enhance QoE of the user in the wireless communication system that supports dual connectivity. This may be performed according to a method determined by a combination of one, two or more of the aforementioned schemes. For example, it may be possible to perform part of an operation in an embodiment in combination with part of an operation in another embodiment.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a storage medium (e.g., a CD-ROM), through an application store, directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

In the embodiments of the disclosure, in a wireless communication system that supports dual connectivity, QoE of the user may be enhanced by evaluating QoE, determining a QoE bottleneck factor, and dynamically controlling traffic steering and QoS throttling.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A centralized unit (CU) for controlling quality of experience (QoE) in a wireless communication system which supports dual connectivity, the CU comprising:
a transceiver; and
at least one processor connected to the transceiver, wherein the at least one processor is configured to:
transmit, to a distributed unit (DU), a message requesting information for determination of QoE bottleneck,
receive, from the DU, a message including the information for determination of QoE bottleneck,
determine a QoE bottleneck factor based on the received information for determination of QoE bottleneck, wherein the QoE bottleneck factor is associated with a traffic state in a radio access network (RAN) or a core network, and
perform QoE control based on the determined QoE bottleneck factor.

2. The CU of claim 1, wherein the CU or the DU is associated with a master node (MN) or a secondary node (SN).

3. The CU of claim 1,
wherein the message requesting information for determination of QoE bottleneck specifies at least one information for determination of QoE bottleneck, and
wherein the at least one processor is configured to receive a message including the specified information for determination of QoE bottleneck, from the DU, in response to the message requesting the information for determination of QoE bottleneck.

4. The CU of claim 1,
wherein the message requesting information for determination of QoE bottleneck indicates to activate or deactivate at least one information for determination of QoE bottleneck, and
wherein the at least one processor is configured to periodically receive, from the DU, a message including the activated information for determination of QoE bottleneck.

5. The CU of claim 1, wherein the at least one processor is further configured to:
receive a policy related to determination of a QoE bottleneck factor; and
determine the QoE bottleneck factor, based on the received policy related to determination of QoE bottleneck factor and the received information for determination of QoE bottleneck.

6. The CU of claim 1, wherein the information for determination of QoE bottleneck comprises at least one of:
radio link control (RLC) buffer occupancy (BO),
transport block size (TBS),
scheduling probability (SP), or
queueing delay.

7. The CU of claim 1, wherein the at least one processor is further configured to:
receive a policy related to QoE evaluation;
receive QoE measurement information from a user equipment (UE);
evaluate QoE based on the received policy related to QoE evaluation and the received QoE measurement information; and
transmit, to the DU, the message requesting information for determination of QoE bottleneck when QoE degradation is detected.

8. The CU of claim 1, wherein the at least one processor is further configured to, in case that the determined QoE bottleneck factor is unbalance of distribution of traffic coming into the RAN, adjust a packet data convergence protocol (PDCP) split ratio of the CU, and transmit, to the DU, data according to the adjusted PDCP split ratio.

9. The CU of claim 1, wherein the at least one processor is further configured to, in case that the determined QoE bottleneck factor is overflow of traffic coming into the RAN, transmit, to the core network, a message for reducing quality of service (QOS) and transmit, to the DU, information about reduced QoS through a protocol data unit (PDU) session modification procedure to reduce traffic coming into the RAN.

10. The CU of claim 1, wherein the at least one processor is further configured to in case that the determined QoE bottleneck factor is underflow of traffic coming into the RAN, transmit, to the core network, a message for increasing QoS and transmit, to the DU, information about increased QoS through a PDU session modification procedure to increase traffic coming into the RAN.

11. A method of operating a centralized unit (CU) for controlling quality of experience (QoE) in a wireless communication system which supports dual connectivity, the method comprising:
transmitting, to a distributed unit (DU), a message requesting information for determination of QoE bottleneck;
receiving, from the DU, a message including the information for determination of QoE bottleneck;
determining a QoE bottleneck factor based on the received information for determination of QoE bottleneck, wherein the QoE bottleneck factor is associated with a traffic state in a radio access network (RAN) or a core network; and
performing QoE control based on the determined QoE bottleneck factor.

12. The method of claim 11,
wherein the message requesting information for determination of QoE bottleneck specifies at least one information for determination of QoE bottleneck, and
wherein the receiving of the message including the information for determination of QoE bottleneck comprises receiving a message including the specified information for determination of QoE bottleneck, from the DU, in response to the message requesting information for determination of QoE bottleneck.

13. The method of claim 11,
wherein the message requesting information for determination of QoE bottleneck indicates to activate or deactivate at least one information for determination of QoE bottleneck, and
wherein the receiving of the message including the information for determination of QoE bottleneck comprises periodically receiving, from the DU, a message including the activated information for determination of QoE bottleneck.

14. The method of claim 11, further comprising:
receiving a policy related to determination of a QoE bottleneck factor; and
determining the QoE bottleneck factor, based on the received policy related to determination of QoE bottleneck factor and the received information for determination of QoE bottleneck.

15. A distributed unit (DU) for controlling quality of experience (QoE) in a wireless communication system which supports dual connectivity, the DU comprising:
a transceiver; and
at least one processor connected to the transceiver, wherein the at least one processor is configured to:
receive, from a centralized unit (CU), a message requesting information for determination of QoE bottleneck,
transmit, to the CU, a message including the information for determination of QoE bottleneck, wherein the information for determination of QoE bottleneck is used to determine a QoE bottleneck factor, and the QoE bottleneck factor is associated with a traffic state in a radio access network (RAN) or a core network, and
receive, from the CU, information about data or changed quality of service (QOS) as a result of performing QoE control based on the QoE bottleneck factor.

16. The DU of claim 15, wherein the CU or the DU is associated with a master node (MN) or a secondary node (SN).

17. The DU of claim 15,
wherein the message requesting information for determination of QoE bottleneck specifies at least one information for determination of QoE bottleneck, and
wherein the at least one processor is configured to transmit a message including the specified information for determination of QoE bottleneck to the CU in response to the message requesting the information for determination of QoE bottleneck.

18. The DU of claim 15,
wherein the message requesting information for determination of QoE bottleneck indicates to activate or deactivate at least one information for determination of QoE bottleneck, and
wherein the at least one processor is configured to periodically transmit, to the CU, a message including the activated information for determination of QoE bottleneck.

19. The DU of claim 15, wherein the information for determination of QoE bottleneck comprises at least one of:
radio link control (RLC) buffer occupancy (BO),
transport block size (TBS),
scheduling probability (SP), or
queueing delay.

20. A method of operating a distributed unit (DU) for controlling quality of experience (QoE) in a wireless communication system which supports dual connectivity, the method comprising:
receiving, from a centralized unit (CU), a message requesting information for determination of QoE bottleneck;
transmitting, to the CU, a message including the information for determination of QoE bottleneck, wherein the information for determination of QoE bottleneck is used to determine a QoE bottleneck factor, and the QoE bottleneck factor is associated with a traffic state in a radio access network (RAN) or a core network; and
receiving, from the CU, information about data or changed quality of service (QoS) as a result of performing QoE control based on the QoE bottleneck factor.
